(19) United States
(12) Patent Application Publication
(10) Pub. No.: US 2026/0289316 A1
(43) Pub. Date: Sep. 24, 2026

(54) MIXED MACHINE LEARNING ARCHITECTURES AND TRAINING TECHNIQUES FOR SEQUENTIAL PREDICTIONS OF MIXED OUTPUT TYPES

(71) Applicant: Optum Services (Ireland) Limited, Dublin (IE)

(72) Inventors: Killian James FARRELL, Co. Dublin (IE); Conor Brian BREEN, Dublin (IE); Kashyap KRISHNAMURTHY, Co. Dublin (IE)

(21) Appl. No.: 19/052,064

(22) Filed: Feb. 12, 2025

(51) Int. Cl. G06N 3/0895; G06N 3/047

(52) U.S. Cl. CPC G06N 3/0895; G06N 3/047

(57) ABSTRACT

Various embodiments of the present disclosure provide a mixed prediction scheme that improves the functionality of a computer in various aspects. The techniques comprise receiving an input sequence comprising a set of input classes and a set of elapsed time indicators respectively corresponding to the set of input classes and generating, using an embedding layer of a mixed model pipeline, a hidden state representation of the input sequence. The techniques comprise inputting the hidden state representation to (i) a connected classification layer of the mixed model pipeline to receive a class prediction based on the hidden state representation and (ii) a connected regression layer of the mixed model pipeline to receive a time prediction based on the hidden state representation and providing an aggregate output for the input sequence that identifies the class prediction and the time prediction.

### BACKGROUND

Machine learning models are traditionally configured for specific output types, which reduces their efficiency with tasks that require simultaneous predictions of outputs of different data types, such as discrete categorical outputs and corresponding continuous temporal outputs. These inefficiencies have historically prevented the use of machine learning approaches for mixed prediction tasks, including sequential prediction tasks that rely on predictions of multiple (e.g., “mixed”) data types. Historically, sequence prediction models have been designed to handle either classification tasks or regression tasks, separately. For example, recurrent neural networks (RNNs) and long short-term memory (LSTM) networks have been used for sequence-to-sequence predictions in natural language processing or time series forecasting. However, these models typically focus on predicting either a single class label or a continuous value, not both simultaneously. This limitation prevents the use of traditional machine learning architectures in mixed prediction tasks where both a next event in a sequence and its timing may be equally influential on the performance (e.g., in terms of accuracy) of the machine learning model.

### BRIEF DESCRIPTION OF THE DRAWINGS

FIG. 1 depicts a block diagram of an example architecture in accordance with some embodiments of the present disclosure.

FIG. 2 depicts a block diagram of an example predictive data analysis computing entity in accordance with some embodiments of the present disclosure.

FIG. 3 depicts a block diagram of an example client computing entity in accordance with some embodiments of the present disclosure.

FIG. 4 depicts a block diagram of a mixed model pipeline in accordance with some embodiments of the present disclosure.

FIG. 5 depicts a dataflow diagram of an iterative prediction scheme in accordance with some embodiments of the present disclosure.

FIG. 6 depicts a dataflow diagram of a mixed training scheme in accordance with some embodiments of the present disclosure.

FIG. 7 depicts an operational example of an indexing stage of a class embedding sublayer in accordance with some embodiments of the present disclosure.

FIG. 8 depicts an operational example of an embedding stage of a class embedding sublayer in accordance with some embodiments of the present disclosure.

FIGS. 9A-B depict operational examples of a concatenation sublayer and concatenated embedding sublayer in accordance with some embodiments of the present disclosure.

FIG. 10 depicts a flowchart diagram of a sequential prediction process in accordance with some embodiments of the present disclosure.

### DETAILED DESCRIPTION

Various embodiments of the present disclosure provide machine learning architectures and training techniques that improve the functionality of a computer with respect to mixed prediction tasks that require prediction of various, distinct data types. To do so, some embodiments of the present disclosure provide a mixed model pipeline that combines classification and temporal predictions to generate improved sequence predictions with less computing resources. To overcome performance deficiencies with traditional machine learning models, the mixed model pipeline introduces a new model architecture specifically designed for mixed prediction tasks. The model architecture comprises an embedding layer that is shared by a multi-headed decoder layer with different models for up to each data type of the mixed prediction task. The multi-headed decoder layer, for example, may comprise a connected classification layer and a connected regression layer that may be trained to decode a shared hidden state representation into a class prediction and a time prediction, respectively. To support both operations, the embedding layer may comprise a set of sublayers specially designed to encode both semantic and temporal features of an original input within the shared hidden state representation. The embedding layer, for example, may comprise a learned embedding lookup table that maps an input class of an input to a learned class embedding followed by a concatenation layer that concatenates the learned class embedding with timing information from the original input. The resulting input embedding may be processed by a third (e.g., sequence model layer) layer to create a hidden state representation that embeds both the semantic and temporal features of the original input. In this way, the mixed model pipeline of the present disclosure enables aggregate predictions, from a single model, that comprise outputs for up to each of a set of data types influential for a mixed prediction task. By doing so, the mixed model pipeline allows for sequential predictions in mixed prediction spaces that are traditionally outside the scope of machine learning approaches due to performance deficiencies (e.g., in terms of accuracy) of traditional model architecture.

In some embodiments, the machine learned architectures of the present disclosure enable improved training techniques that further improve the functionality of a computer with respect to machine learning training. The multi-headed decoder structure of the machine learning pipeline, for example, may enable the joint optimization of multiple machine learning tasks, such as classification and regression tasks, through the use of a dual loss function that combines disparate machine learning loss metrics into a universal loss value reflective of the machine learning pipeline’s overall performance (e.g., in terms of accuracy) with respect to the multiple machine learning tasks. This allows for improved training performance, in terms of speed and training efficiency, relative to traditional machine learning approaches that rely on separate models for classification and regression.

In some embodiments, the training techniques of the present disclosure may train the mixed model pipeline end to end to encode both semantic and temporal relationships at up to every layer of the pipeline. This enables improved learned class embeddings, as well as derivative embeddings, such as the shared hidden stage representations output by the embedding layer, that may be optimized with respect to multiple prediction goals associated with a mixed prediction task. Through the use of these improved embeddings, the training techniques of the present disclosure may improve the overall performance (e.g., in terms of accuracy) of the end-to-end machine learning model, while reducing the training time until convergence relative to existing machine learning approaches. This, in turn, improves the training functionality of a computer by reducing the time and processing/storage requirements of training machine learning models for mixed prediction tasks. By doing so, the training techniques of the present disclosure may be executed on a more frequent timeline to monitor and address potential performance deficiencies due to data drift, among other anomalies that may negatively impact a machine learning model’s performance.

Examples of technologically advantageous embodiments of the present disclosure comprise an improved distribution of machine learning components that operate in an unconventional fashion to improve the predictive and training functionality of a computer, among other aspects of the present disclosure. Other technical improvements and advantages may be realized by one of ordinary skill in the art.

### Overview of Embodiments

As should be appreciated, various embodiments of the present disclosure may be implemented as methods, apparatus, systems, computing devices, computing entities, computer program products, and/or the like. As such, embodiments of the present disclosure may take the form of an apparatus, system, computing device, computing entity, and/or the like executing instructions stored on a computer-readable storage medium to perform certain steps or operations. Thus, embodiments of the present disclosure may take the form of an entirely hardware embodiment, an entirely computer program product embodiment, and/or an embodiment that comprises a combination of computer program products and hardware performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some example embodiments, retrieval, loading, and/or execution may be performed in parallel such that multiple instructions are retrieved, loaded, and/or executed together. Thus, such embodiments may produce specifically configured machines performing the steps or operations specified in the block diagrams and flowchart illustrations. Accordingly, the block diagrams and flowchart illustrations support various combinations of embodiments for performing the specified instructions, operations, or steps.

### Example Framework

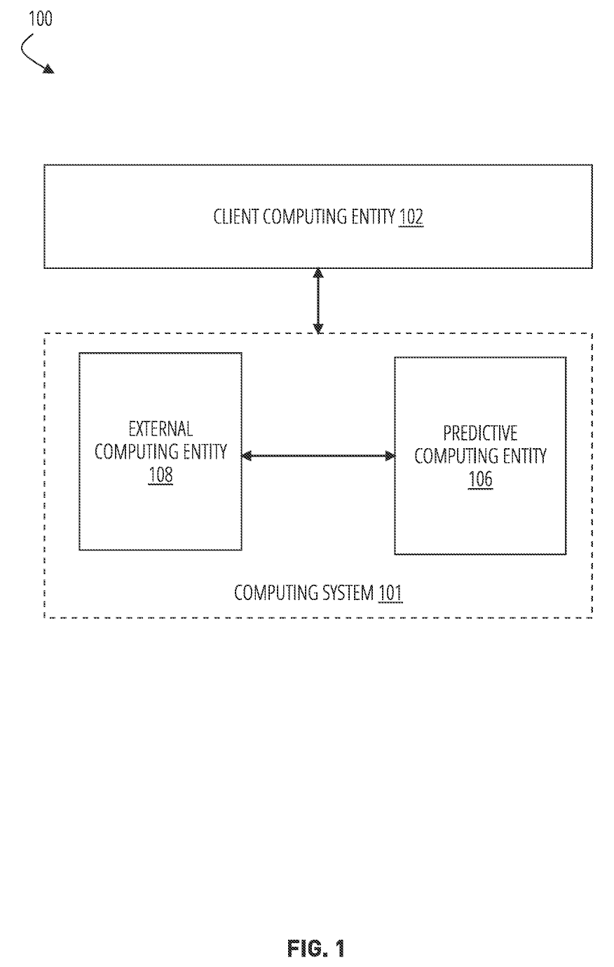

FIG. 1 depicts a block diagram of an example architecture 100 in accordance with some embodiments of the present disclosure. The architecture 100 comprises a computing system 101 configured to receive a request, such as a sequential prediction request comprising input data for a target entity, training request comprising training data for a training entity, and/or the like, from client computing entities 102, process the sequential prediction request, and provide responses, such as a predicted sequence, to the client computing entities 102. The example architecture 100 may be used in a plurality of domains and not limited to any specific application as disclosed herewith. The plurality of domains may comprise healthcare, industrial, manufacturing, computer security, and/or the like to name a few.

In accordance with various embodiments of the present disclosure, one or more machine learned models may be trained to generate component outputs of a predicted sequence. The models may be adapted to a mixed prediction task that may simultaneously predict outputs of different data types from a single input. Some techniques of the present disclosure may adapt traditional models to a cohesive framework, such as the mixed model pipeline, for enabling more accurate, efficient, and timely training and inference operations for a mixed prediction task.

In some embodiments, the computing system 101 may communicate with at least one of the client computing entities 102 using one or more communication networks. Examples of communication networks comprise any wired or wireless communication network comprising, for example, a wired or wireless local area network (LAN), personal area network (PAN), metropolitan area network (MAN), wide area network (WAN), or the like, as well as any hardware, software, and/or firmware required to implement it (such as, e.g., network routers, and/or the like).

The computing system 101 may comprise a predictive computing entity 106 and one or more external computing entities 108. The predictive computing entity 106 and/or one or more external computing entities 108 may be individually and/or collectively configured to receive requests from client computing entities 102, process the requests to generate a code predictions, and provide the code predictions to the client computing entities 102.

For example, as discussed in further detail herein, the predictive computing entity 106 and/or one or more external computing entities 108 comprise storage subsystems that may be configured to store input data, training data, and/or the like that may be used by the respective computing entities to perform predictive data analysis and/or training operations of the present disclosure. In addition, the storage subsystems may be configured to store model definition data used by the respective computing entities to perform various predictive data processing and/or training tasks. The storage subsystem may comprise one or more storage units, such as multiple distributed storage units that are connected through a computer network. A storage unit in the respective computing entities may store at least one of one or more data assets and/or a set of data about the computed properties of one or more data assets. Moreover, each storage unit in the storage systems may comprise one or more non-volatile storage or volatile storage media similar to or different than the non-volatile and/or volatile computer-readable storage media discussed above.

In some embodiments, the predictive computing entity 106 and/or one or more external computing entities 108 are communicatively coupled using one or more wired and/or wireless communication techniques. The respective computing entities may be configured according to the techniques described herein to perform one or more operations of one or more techniques described herein. By way of example, the predictive computing entity 106 may be configured to train, implement, use (e.g., execute an inference operation(s)), update (e.g., fine-tune), and evaluate machine learning models in accordance with one or more training and/or inference operations of the present disclosure. In some examples, the external computing entities 108 may be configured to train, implement, use, update, and evaluate machine learning models in accordance with one or more training and/or inference operations of the present disclosure.

In some example embodiments, the predictive computing entity 106 may be configured to receive and/or transmit one or more datasets, objects, and/or the like from and/or to the external computing entities 108 to perform one or more steps/operations of one or more techniques (e.g., mixed prediction inference, model training techniques) described herein. The external computing entities 108, for example, may comprise and/or be associated with one or more entities that may be configured to receive, transmit, store, manage, and/or facilitate datasets, and/or the like. The external computing entities 108, for example, may comprise data sources that may provide such datasets, and/or the like to the predictive computing entity 106 which may leverage the datasets, such as input datasets, embedding lookup tables, and/or the like to perform one or more steps/operations of the present disclosure, as described herein. In some examples, the datasets may comprise an aggregation of data from across a plurality of external computing entities 108 into one or more aggregated datasets. The external computing entities 108, for example, may be associated with one or more data repositories, cloud platforms, compute nodes, organizations, and/or the like, which may be individually and/or collectively leveraged by the predictive computing entity 106 to obtain and aggregate data for an information domain.

In some example embodiments, the predictive computing entity 106 may be configured to receive a trained machine learning model trained and subsequently provided by the one or more external computing entities 108. For example, the one or more external computing entities 108 may be configured to perform one or more training steps/operations of the present disclosure to train a machine learning model, as described herein. In such a case, the trained machine learning model may be provided to the predictive computing entity 106, which may leverage the trained machine learning model to perform one or more inference steps/operations of the present disclosure. In some examples, feedback (e.g., evaluation data, ground truth data) from the use of the machine learning model may be received and/or stored by the predictive computing entity 106. In some examples, the feedback may be provided to the one or more external computing entities 108 to continuously train the machine learning model over time. In some examples, the feedback may be leveraged by the predictive computing entity 106 to continuously train the machine learning model over time. In this manner, the computing system 101 may perform, via one or more combinations of computing entities, one or more prediction, training, and/or any other machine learning-based techniques of the present disclosure.

### Example Computing Entity

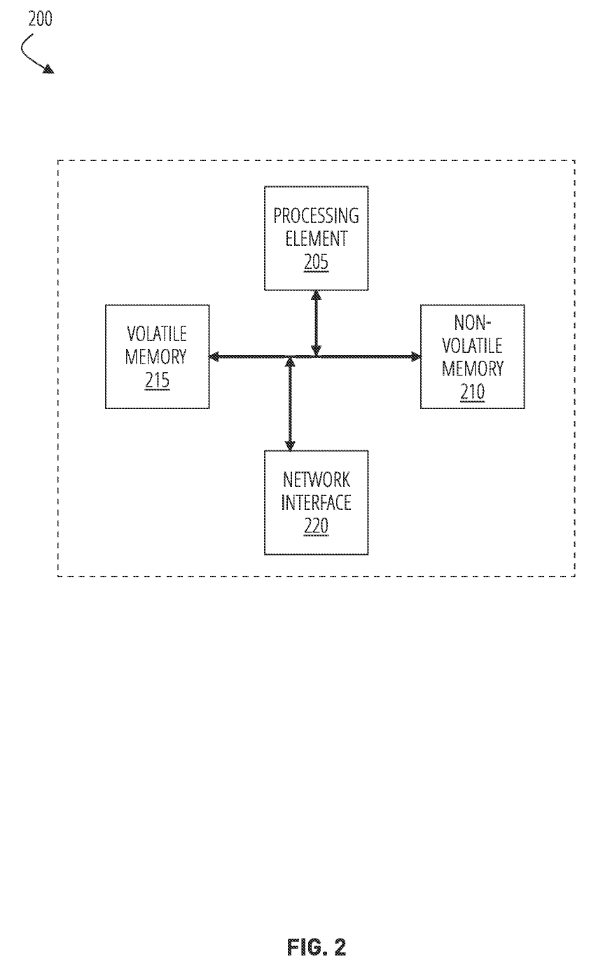

FIG. 2 depicts a block diagram of an example computing entity 200 in accordance with some embodiments of the present disclosure. The computing entity 200 is an example of the predictive computing entity 106 and/or external computing entities 108 of FIG. 1. In general, the terms computing entity, computer, entity, device, system, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may comprise, for example, transmitting, receiving, operating on, processing, displaying, storing, determining, creating/generating, training one or more machine learning models, monitoring, evaluating, comparing, and/or similar terms used herein interchangeably. In some embodiments, these functions, operations, and/or processes may be performed on data, content, information, and/or similar terms used herein interchangeably. In some embodiments, the one computing entity (e.g., predictive computing entity 106) may train and use one or more machine learning models described herein. In other embodiments, a first computing entity (e.g., predictive computing entity 106, which may be one or more predictive computing entities) may use one or more machine learning models that may be trained by a second computing entity (e.g., external computing entity 108) communicatively coupled to the first computing entity. The second computing entity, for example, may train one or more of the machine learning models described herein, and subsequently provide the trained machine learning model(s) (e.g., optimized weights, code sets) to the first computing entity over a network.

As shown in FIG. 2, in some embodiments, the computing entity 200 may comprise, or be in communication with, one or more processing elements 205 (also referred to as processors, processing circuitry, and/or similar terms used herein interchangeably) that communicate with other elements within the computing entity 200 via a bus, for example. As will be understood, the processing element 205 may be embodied in a number of different ways.

For example, the processing element 205 may be embodied as one or more complex programmable logic devices (CPLDs), microprocessors, multi-core processors, arithmetic logic units (ALUs) (e.g., which may be part of one or more graphics processing units (GPUs), tensor processing units (TPUs), and/or the like), coprocessing entities, application-specific instruction-set processors (ASIPs), microcontrollers, and/or controllers. Additionally, or alternatively, the processing element 205 may be embodied as one or more other processing devices and/or circuitry. The term circuitry may refer to an entirely hardware embodiment or a combination of hardware and computer program products. Examples of a combination of hardware and computer program products comprise application specific integrated circuits (ASICs), field programmable gate arrays (FPGAs), programmable quantum gate arrays, programmable logic arrays (PLAs), hardware accelerators, other circuitry, and/or the like. With respect to quantum computing embodiments of the computing entity 200, the processing element 205 may comprise specialized components for manipulating and measuring quantum states. These components may comprise quantum gates that perform operations on one or more qubits, quantum circuits that combine multiple gates to implement algorithms, measurement devices that extract classical information from quantum state, and/or the like. The quantum gates, circuits, and/or the like may be controlled, using one or more error correction mechanisms to compensate for decoherence and other quantum noise effects, to maintain quantum coherence while performing computations.

As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present disclosure when configured accordingly.

In some embodiments, the computing entity 200 may further comprise, or be in communication with, non-transitory computer readable media, such as non-volatile memory 210 (also referred to as non-volatile media, storage, memory storage, memory circuitry, and/or similar terms used herein interchangeably), volatile memory 215 (also referred to as volatile media, storage, memory storage, memory circuitry, and/or similar terms used herein interchangeably), quantum memory (e.g., solid quantum memory, atomic gas quantum memory), and/or the like.

In some embodiments, non-volatile memory 210 may comprise a computer-readable storage medium may comprise a floppy disk, flexible disk, hard disk, solid-state storage (SSS) (e.g., a solid-state drive (SSD), solid-state card (SSC), solid-state module (SSM)), enterprise flash drive, magnetic tape, or any other non-transitory magnetic medium, and/or the like. A non-volatile computer-readable storage medium may also comprise a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also comprise read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also comprise conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In some embodiments, volatile memory 215 may comprise a computer-readable storage medium comprising random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (comprising various levels), flash memory, register memory, and/or the like. It will be appreciated that where embodiments are described to use a computer-readable storage medium, other types of computer-readable storage media may be substituted for or used in addition to the computer-readable storage media described above.

In some embodiments, quantum memory comprises a memory structure that utilize quantum bits, or qubits, which may exist in multiple states simultaneously through a property called superposition. Unlike classical bits that may only be in a state of 0 or 1, qubits may represent both states at once, allowing for exponentially larger information storage capacity. These quantum memory structures must maintain quantum coherence, which refers to the delicate quantum mechanical state of the system, while also allowing for rapid access and manipulation of stored quantum information.

As will be recognized, the non-volatile memory 210, the volatile memory 215, and/or the quantum memory may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 205. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

Thus, the databases, database instances, database management systems, data, applications, programs, program modules, code (source code, object code, byte code, compiled code, interpreted code, machine code) that embodies one or more machine learning models or other computer functions described herein, executable instructions, and/or the like may be used to control certain aspects of the operation of the computing entity 200 by operating the processing element 205 according to software component(s) retrieved from any of the computer-readable storage media and executed by the processing element 205.

Embodiments of the present disclosure may be implemented in various ways, including as computer program products that comprise articles of manufacture. Such computer program products may comprise one or more software components including, for example, software objects, methods, data structures, or the like. A software component may be coded in any of a variety of programming languages. An illustrative programming language may be a lower-level programming language such as an assembly language associated with a particular hardware architecture and/or operating system platform. A software component comprising assembly language instructions may require conversion into executable machine code by an assembler prior to execution by the hardware architecture and/or platform. Another example programming language may be a higher-level programming language that may be portable across multiple architectures. A software component comprising higher-level programming language instructions may require conversion to an intermediate representation by an interpreter or a compiler prior to execution.

Other examples of programming languages comprise, but are not limited to, a macro language, a shell or command language, a job control language, a script language, a database query or search language, and/or a report writing language. In one or more example embodiments, a software component comprising instructions in one of the foregoing examples of programming languages may be executed directly by an operating system or other software component without having to be first transformed into another form, such as object code, or may be first transformed into another form, such as by compiling source code. A software component may be stored as a file or other data storage construct. Software components of a similar type or functionally related may be stored together such as, for example, in a particular directory, folder, or library. Software components may be static (e.g., pre-established, or fixed) or dynamic (e.g., created or modified at the time of execution).

A computer program product may comprise a non-transitory computer-readable storage medium storing one or more software components comprising application(s), program(s), program module(s), script(s), source code and/or compiler(s) for generating executable instructions such as object code using the source code, program code, object code, byte code, compiled code, interpreted code, machine code, executable instructions, and/or the like (e.g., executable instructions, instructions for execution, computer program products, program code, and/or similar terms used herein interchangeably). Such non-transitory computer-readable storage media comprise all computer-readable storage media (including volatile memory 215 and non-volatile memory 210). In some embodiments, the computer program product may be executed by the computing entity 200 and/or the client computing entity. For example, at least a first portion of the computer program product may be stored within the volatile memory 215 and/or non-volatile 210 of the computing entity 200. In addition, or alternatively, at least a second portion of the computer program product may be stored within the volatile and/or non-volatile memory of a client computing entity.

In some embodiments, one or more embodiments of the present disclosure may be implemented using general and/or specialized quantum computers. For example, the computing entity 200 may comprise quantum memory and/or quantum processing elements, as described herein, that may be configured for general processing and/or specialized processing tasks. In some examples, the quantum memory and/or quantum processing elements of the computer entity 200 may be specialized for machine learning task. By way of example, large language models (LLMs) and other transformer networks may be specially designed for operation within a quantum environment by replacing weight matrices in self-attention and/or multi-layer perceptron layers of such models with one or more combinations of two variational quantum circuits and/or a quantum-inspired tensor networks, such as a matrix product operator (MPO). In this way, LLM functionality may be enabled within a quantum environment by decomposing weight matrices through the application of tensor network disentanglers and MPOs. Similarly, quantum support vector machines, quantum neural networks, and/or any other machine learning architecture may be modified to a quantum environment for implementation by the computing entity 200. Thus, the machine learning architectures of the present disclosure may be configured for classical computer or quantum computers based on the embodiment.

As indicated, in some embodiments, the computing entity 200 may also comprise one or more network interfaces 220 for communicating with various computing entities (e.g., the client computing entity 102, external computing entities), such as by communicating data, code, content, information, and/or similar terms used herein interchangeably that may be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. In some embodiments, the computing entity 200 communicates with another computing entity for uploading or downloading data or code (e.g., data or code that embodies or is otherwise associated with one or more machine learning models). Similarly, the computing entity 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Global System for Mobile Communications (GSM), Enhanced Data rates for GSM Evolution (EDGE), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, IEEE 802.16 (WiMAX), ultra-wideband (UWB), infrared (IR) protocols, near field communication (NFC) protocols, Wibree, Bluetooth protocols, wireless universal serial bus (USB) protocols, and/or any other wireless protocol.

Although not shown, the computing entity 200 may additionally or alternatively comprise, or be in communication with, one or more input elements/devices, such as input sensor(s). In some examples, the input sensor(s) may comprise one or more keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like. The computing entity 200 may additionally or alternatively comprise, or be in communication with, one or more output elements/devices (not shown), such as one or more speakers, visual display devices, haptic feedback devices, motion devices (e.g., electromechanically actuated devices), and/or the like.

### Example Client Computing Entity

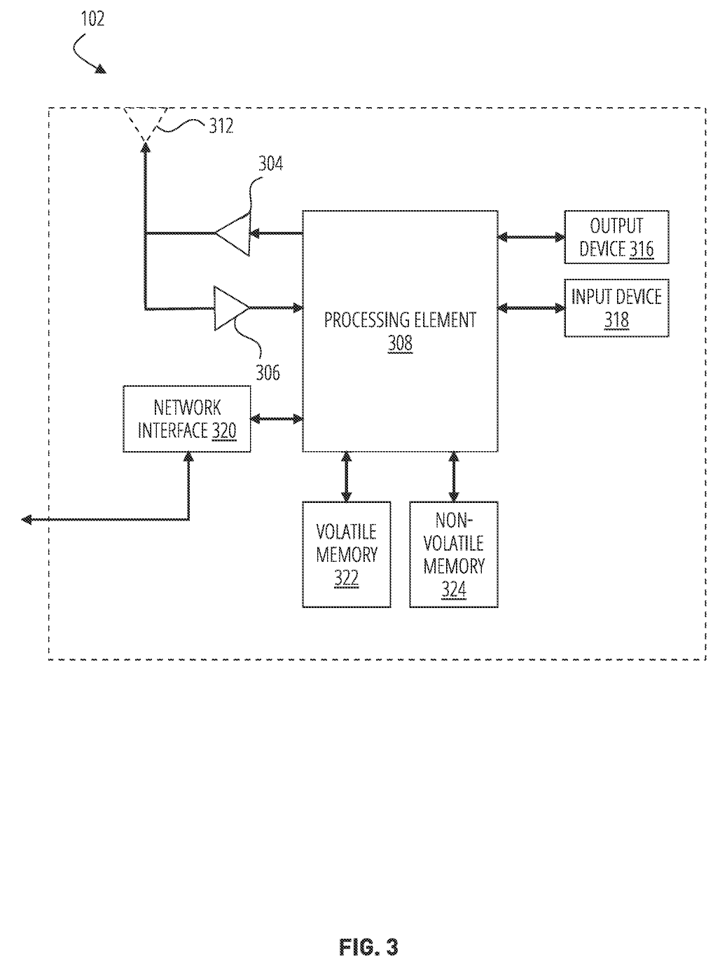

FIG. 3 depicts a block diagram of an example client computing entity in accordance with some embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Client computing entities 102 may be operated by various parties. As shown in FIG. 3, the client computing entity 102 may comprise an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, correspondingly.

The signals provided to and received from the transmitter 304 and the receiver 306, correspondingly, may comprise signaling information/data in accordance with air interface standards of applicable wireless systems. In this regard, the client computing entity 102 may be capable of operating with one or more air interface standards, communication protocols, modulation types, and access types. More particularly, the client computing entity 102 may operate in accordance with one or more wireless and/or wired communication standards and protocols, such as those described above with regard to the computing entity 200.

The client computing entity 102 may additionally or alternatively download code, changes, add-ons, and updates, for instance, to its firmware, software (e.g., including executable instructions, applications, program modules), and operating system.

According to some embodiments, the client computing entity 102 may comprise location determining aspects, devices, modules, functionalities, and/or similar words used herein interchangeably. For example, the client computing entity 102 may comprise outdoor positioning aspects, such as a location component adapted to acquire, for example, latitude, longitude, altitude, geocode, course, direction, heading, speed, universal time (UTC), date, and/or various other information/data. In some embodiments, the location component may acquire data, sometimes known as ephemeris data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This data may be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information/data may be determined by triangulating the position of the client computing entity 102 in connection with a variety of other systems, including cellular towers, Wi-Fi access points, and/or the like. Similarly, the client computing entity 102 may comprise indoor positioning aspects, such as a location component adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops), and/or the like. For instance, such technologies may comprise the iBeacons, Gimbal proximity beacons, Bluetooth Low Energy (BLE) transmitters, NFC transmitters, and/or the like. These indoor positioning aspects may be used in a variety of settings to determine the location of someone or something to within inches or centimeters.

The client computing entity 102 may also comprise a user interface that may comprise an output device 316 coupled to a processing element 308 and/or a user input device 318 coupled to the processing element 308. An output device 316, for example, may comprise a hardware computing device comprising one or more output elements (not shown), such as one or more speakers, visual display devices, haptic feedback devices, motion devices (e.g., electromechanically actuated devices), and/or the like. A user input device 318 may comprise the same or different hardware computing device comprising one or more input elements (not shown), such as keyboards, pointing devices (e.g., mouse, trackpad), touch screens, cameras (e.g., infrared light camera, visual light camera), depth sensors (e.g., LIDAR, radar, stereo cameras), gyroscopes, location sensors (e.g., global positioning system (GPS), Hall effect sensor, laser doppler vibrometer), microphones, and/or the like.

In some examples, the user interface may additionally or alternatively comprise software component(s) executed by the processing element 308 to present (e.g., audibly, visually, tactilely) via a user input device 318 and/or output device 316 and/or a software endpoint such as an application programming interface (API) or exposed software function a graphical user interface (GUI) (e.g., at least a portion of a user application, browser), command-line interface, touch and/or haptic user interface, gesture and/or image capture-based interface, voice/audio user interface, and/or the like used herein interchangeably executing on and/or accessible via the client computing entity 102 to interact with and/or cause display of information/data from the computing entity 200, as described herein. In addition to providing input, the user input interface may be used, for example, to activate, deactivate, and/or modify certain functions, such as altering a power or operating state of the client computing entity 102, the computing system 101, the predictive computing entity 106, and/or the external computing entity 108.

The client computing entity 102 may further comprise, or be in communication with, one or more memory components, such as the volatile memory 322 and/or non-volatile memory 324. For example, the memory components may comprise non-transitory computer readable media, such as non-volatile memory 324 (also referred to as non-volatile storage, memory, memory storage, memory circuitry, and/or similar terms used herein interchangeably) and/or volatile memory 322 (also referred to as volatile storage, memory, memory storage, memory circuitry, and/or similar terms used herein interchangeably), as discussed above with reference to FIG. 2.

As will be recognized, the non-volatile memory 324 and/or the volatile memory 322 may store respective part(s) of one or more databases, database instances, database management systems, data, applications, programs, program modules, scripts, code (e.g., source code, object code, byte code, compiled code, interpreted code, machine code) that embodies one or more machine learning models or other computer functions described herein, executable instructions, and/or the like being executed by, for example, the processing element 308. The term database, database instance, database management system, and/or similar terms used herein interchangeably, may refer to a collection of records or data that is stored in a computer-readable storage medium using one or more database models; such as a hierarchical database model, network model, relational model, entity-relationship model, object model, document model, semantic model, graph model, and/or the like.

In another embodiment, the client computing entity 102 may comprise one or more components or functionalities that are the same or similar to those of the computing entity 200, as described in greater detail above. In one such embodiment, the client computing entity 102 downloads, e.g., via network interface 320, code embodying machine learning model(s) from the computing entity 200 so that the client computing entity 102 may run a local instance of the machine learning model(s). As will be recognized, these architectures and descriptions are provided for example purposes only and are not limited to the various embodiments.

In various embodiments, the client computing entity 102 may be embodied as an artificial intelligence (AI) computing entity (e.g., an intelligent agent machine-learned model), such as AutoGPT, Mycroft, Rhasspy, and/or the like. Accordingly, the client computing entity 102 may be configured to provide and/or receive information/data from a user via an input/output mechanism, such as a display, a camera, a speaker, a voice-activated input, and/or the like. In certain embodiments, an AI computing entity may comprise one or more predefined and executable program algorithms stored within an onboard memory storage component, and/or accessible over a network. In various embodiments, the AI computing entity may be configured to retrieve and/or execute one or more of the predefined program algorithms upon the occurrence of a predefined trigger event.

### Example System Operations

As indicated, various embodiments of the present disclosure make important technical contributions to computer and machine learning functionality. In particular, systems and methods are disclosed herein that implement machine learning inference and training techniques to improve both the predictive accuracy of a computer and the applicability of machine learning to domains, such a sequential predictions for mixed prediction tasks, that have historically resided outside the scope of traditional machine learning architectures. By doing so, the machine learning inference and training techniques of the present disclosure enable improved machine learning processes that, when executed on a computer, improves training and inference capabilities of computer technology. This, in turn, may improve the functionality of a computer with respect to various computing tasks, including prediction tasks, network security, and/or the like.

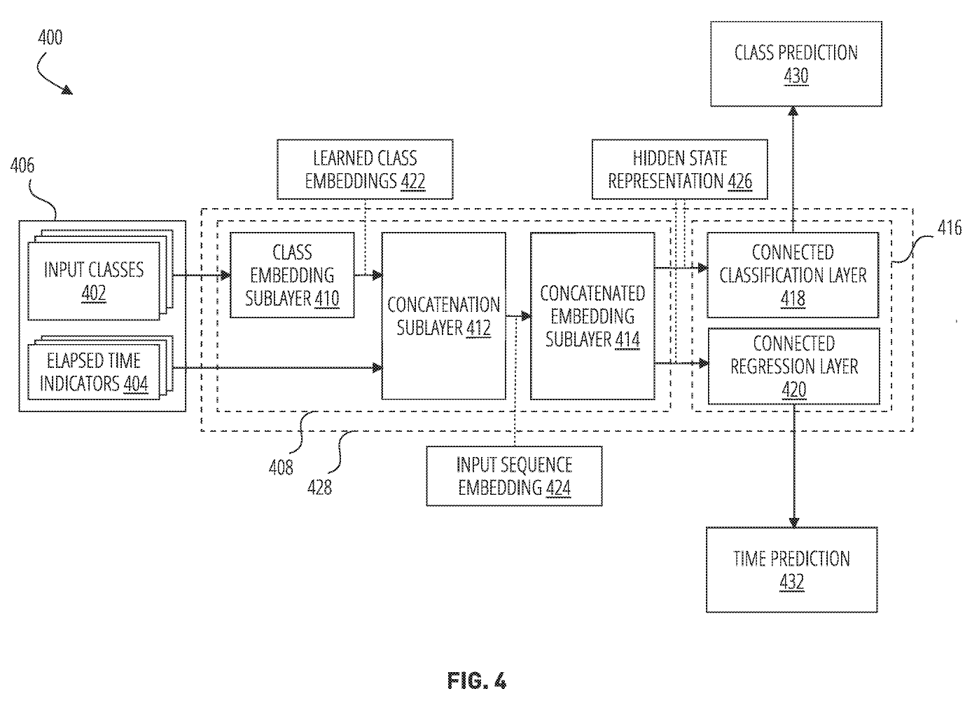

FIG. 4 depicts a block diagram 400 of a mixed model pipeline in accordance with some embodiments of the present disclosure. The mixed model pipeline 428, for example, may comprise an embedding layer 408 and a decoding layer 416 that are specially configured to jointly output predictions of different data types (e.g., a class prediction 430 and a time prediction 432) from a single input sequence 406. To enable sequential predictions with improved accuracy relative to traditional sequential machine learning models, the mixed model pipeline 428 comprises a single embedding layer 408 that is connected to both a connected classification layer 418 and a connected regression layer 420. In some examples, the embedding layer 408, the connected classification layer 418, and/or the connected regression layer 420 may be jointly trained to learn the dependencies between different, traditionally incompatible data types (e.g., a discrete, categorical value type and a continuous, variable value type) at both an encoding and decoding stage of the machine learning model. This allows for improved accuracy with respect to both sequential class and timing predictions that enables sequential predictions (e.g., predictions that may be fed back to a machine learning model to iteratively predict outputs for subsequent time periods) for mixed prediction tasks that have historically presented technical challenges for traditional machine learning architectures.

In some embodiments, a mixed prediction task comprises a prediction task that involves overlapping predictions of mixed data types, such as a categorical data type and a continuous data type. Mixed prediction tasks present unique challenges in machine learning as many machine learning architectures are specialized with respect to a particular data type. This tendency towards specialization makes mixed prediction tasks unsuitable for most traditional architectures, such as classification architectures specialized for categorical or binary predictions, regression architectures that are specialized for continuous predictions, and/or the like.

A mixed prediction task may comprise any predictive task that involves at least two data types. For instance, a mixed prediction task may comprise a temporal prediction task that is configured to predict a future classification and a timing of the classification. In such a case, the classification prediction may require a binary or categorical prediction (e.g., one of a set of possible classifications), whereas the timing prediction may require a continuous, unrestrained prediction (e.g., a number of days). Such tasks may be applicable to any domain. For instance, in a clinical domain, a mixed prediction task may comprise a coordination of benefits (COB) use case in which, for a COB scenario, one of several different COB stages may occur at any time after a preceding stage. In such a case, both the COB stage and the timing of that stage may be predictive of a subsequent stage or, more generally, an ultimate resolution of the COB scenario. As another example, in a network computing domain, a network attack may be precipitated by a series of detectable computing signatures (e.g., spikes in processing usage, interaction with an unknown computing entity, denied requests) that may occur at any time relative to one another. In such a case, both the computing signature and the timing of that signature may be predictive of a subsequent signature or, more generally, an ultimate resolution of the network attack.

To address the technical challenges of mixed data types, embodiments of the present disclosure provide a mixed model pipeline 428 that integrates traditionally incompatible machine learning architectures within a single machine learning framework with a shared embedding layer 408. The mixed model pipeline 428, for example, may comprise a model architecture that is configured to generate mixed predictions, such as classification (e.g., binary or categorical) and temporal (e.g., continuous) predictions based on an input sequence 406. More generally, the mixed model pipeline 428 may comprise an end-to-end machine learning framework that is designed to handle mixed prediction tasks by combining multiple components to process input data and produce multi-faceted predictions, such as an aggregate output with a class prediction 430 and corresponding time prediction 432.

As depicted, the mixed model pipeline 428 may comprise a series of interconnected layers. The series of interconnected layers may comprise a shared embedding layer 408 that comprises one or more sublayers configured to process, embed, and concatenate class and temporal features from an input to generate a hidden state representation 426 of the input. The one or more sublayers, for example, may comprise a class embedding sublayer 410 (e.g., an embedding lookup table, one or more neural network layers) for handling class features from an input, a concatenation sublayer 412 for combining the class features with temporal features, and/or a concatenated embedding sublayer 414 (e.g., recurrent layers, such as long short-term memory (LSTM), gated recurrent unit (GRU)) for handling the combination of class and timing features (and/or the sequential nature thereof) of the input. In addition, or alternatively, the series of interconnected layers may comprise a decoding layer 416 that comprises a set of output heads for decoding the hidden state representation 426 of the shared embedding layer 408 into predictions of different data types. The set of output heads, for example, may comprise a connected classification layer 418 configured, trained, and/or the like to generate a binary and/or categorical discrete prediction from the hidden state representation 426 and/or a connected regression layer 420 configured, trained, and/or the like to generate a temporal, continuous prediction from the hidden state representation 426.

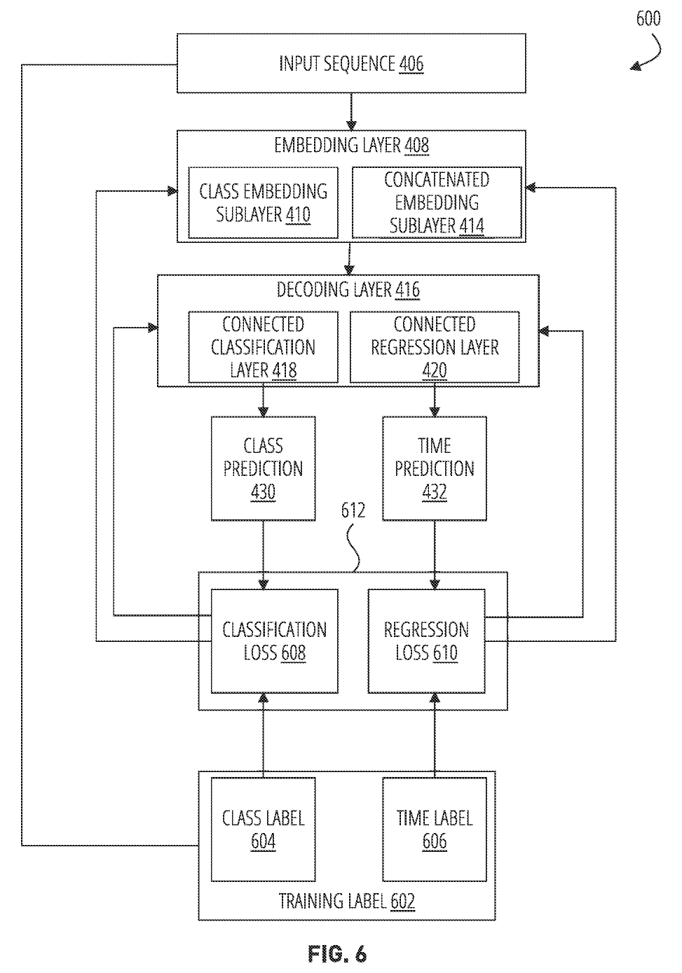

In some embodiments, the mixed model pipeline 428 is configured to process input sequences 406 that may be constrained by a sequence length threshold, as described herein. As described in further detail with reference to FIG. 6, the mixed model pipeline 428 may be trained to jointly optimize (e.g., improve within a calibration threshold) the accuracy of the mixed model pipeline 428 with respect to the outputs of each of the different data types. To do so, during training, various components of the mixed model pipeline 428, such as the class embedding sublayer 410, the concatenated embedding sublayer 414, the connected classification layer 418, the connected regression layer 420, and/or the like, may be trained end-to-end, using a machine training technique, such as backpropagation of errors as optimized using gradient descent, to learn from both classification and regression targets, simultaneously, by optimizing (e.g., maximizing or minimizing) a dual loss function that combines training insights from the performance of up to each of the set of output heads of the decoding layer 416.

In some embodiments, the computing system 101 receives an input sequence 406 comprising a set of input classes 402 and a set of elapsed time indicators 404 respectively corresponding to the set of input classes 402. The input sequence 406 may be received and/or determined from input data associated with a target entity.

In some embodiments, the input sequence 406 comprises a set of input classes and a set of corresponding elapsed time indicators. An input sequence, for example, may represent a series of observed or predicted events, states, and/or the like and a time measurement for up to each of the series of observed or predicted events, states, and/or the like that together form the basis for a sequential, mixed prediction task. An input sequence 406 may comprise a data structure, such as an array, structured data object, list of tuples, and/or the like that may store categorical, numerical, and/or sequential information. As described herein, an input sequence 406 may comprise a set of input classes 402 and elapsed time indicators 404 that may be received and/or determined from one or more observations. In addition, or alternatively, one or more of the set of input classes 402 and elapsed time indicators 404 may comprise predicted values that may be generated by one or more preceding iterations of the mixed model pipeline 428.

In some embodiments, an input class of the set of input classes 402 comprises one of a set of defined classes for a mixed prediction task. A defined class, for example, may comprise a categorical classification that corresponds to one of a set of events, outcomes, states, stages, and/or the like, that may be observed within a mixed prediction task. In this respect, a set of defined classes may depend on the prediction domain of the mixed prediction task. As an example, in a clinical domain, such as the COB use case described herein, a set of defined classes may comprise a set of COB stages, such as an offset pending stage, an investigation start or complete stage, an offset request stage, and/or the like, that correspond to different actions taken for a medical claims during a COB process. As another example, in the network computing domain, such as the network attack tracking use case described herein, the set of defined classes may comprise a set of detectable computing signatures, such as resource usage spike, unknown computing entity touchpoint, denied authorization request, and/or the like, that may precipitate a network attack.

In some examples, the set of defined classes may comprise categorical variables of a multi-classification task. For example, the set of defined classes may comprise a discrete set of possible outcomes for the categorical aspect of a prediction. For instance, the set of defined classes may form one component (e.g., a classification component) of a mixed prediction tasks. In a training phase of a mixed model pipeline 428, the set of defined classes may serve as target variables for the classification portion of the mixed prediction task. During inference, the mixed model pipeline 428 may generate a probability distribution over the set of defined classes to predict a future class from the set of defined classes based on the preceding occurrences of a subset of the set of defined classes (e.g., the set of input classes) and the timing (e.g., elapsed time indicators 404) of the preceding occurrences of the subset of the set of defined classes.

In some embodiments, an elapsed time indicator of the set of elapsed time indicators 404 comprises a data value that identifies an observed or predicted timing of an input class of the set of input classes 402 of the input sequence 406. The elapsed time indicator may comprise any unit of time, such as a time duration, time point, and/or the like. In some examples, the elapsed time indicator may comprise a time duration (e.g., in terms of seconds, hours, days, weeks, months, years) between the occurrence of an input class and a preceding event. The preceding event, for example, may comprise a preceding input class in the input sequence 406, a starting point of the input sequence 406, and/or the like. By way of example, an elapsed time indicator for an input class may identify a duration of time (e.g., elapsed days) between a starting point and the observed or predicted occurrence of the input class. The starting point may comprise an initial time point of a mixed prediction task. By way of example, the starting point may comprise a moment in time (e.g., a day) at which a COB process is started, a potential network attack is identified for tracking, and/or the like.

In some examples, the set of elapsed time indicators 404 may be implemented as numerical values, such as floating-point numbers, and/or the like, to allow for precise time measurements. The set of elapsed time indicators 404 may be stored in arrays, as columns in a database, as attributes in more complex data structures, and/or the like. The time unit (e.g., seconds, minutes, days) and/or numerical representation thereof may depend on the specific application and/or the granularity of time relevant to the mixed prediction task. In any time unit or numerical representation, the set of elapsed time indicators may provide a continuous, temporal dimension to complement the discrete, categorical dimension provided by the corresponding set of input classes 402 of the input sequence 406. This allows the mixed model pipeline 428 to capture and predict both what will happen next and when it will happen.

In some embodiments, the computing system 101 generates the input sequence 406 from input data associated with a target entity. The input data, for example, may comprise raw, structured and/or unstructured data associated with a target entity. The input data may depend on the prediction domain. As an example using a clinical prediction domain, the input data may be aggregated from claim recovery platforms (e.g., that comprise details, such as a date a claim was identified, who identified the claim, and whether the claim was recovered or closed), offset data (e.g., when a provider requests to offset the money they owe against their existing balance, they submit an offset request. The offset may then be approved or rejected, and the timing of these steps play an important role in the likelihood of recovery or closure. A rejected offset request may also trigger a provider appeal), appeals data (e.g., a provider may submit an appeal if they disagree that there was an overpayment. Provider appeals may then trigger a COB investigation into a member), COB investigation data (e.g., once a member is manually investigated for COB, if it is found the member no longer has COB this will directly lead to a COB closure), other insurance data (e.g., this information may be added or removed by a few different areas in the business to indicate a member has COB, and depending on the source of that information, it will affect the likelihood of recovery), supplementary data (e.g., specific details on a claims, members and providers). As another example using a network security domain, the input data may be aggregated from computer monitoring servers,

In some examples, the computing system 101 may extract a set of input classes 402 and a set of elapsed time indicators 404 from the input data. For instance, the computing system 101 may apply one or more natural language processing (NLP) techniques (e.g., string matching) to the input data to identify and extracted defined classes within the input data. In some examples, the computing system 101 may assign an elapsed time indicator to up to each of the set of input classes 402 based on one or more time stamps within the input data. The computing system 101 may arrange the set of input classes in accordance with their timestamps (and/or elapsed time indicators derived therefrom) to generate an initial input sequence for a target entity.

In some embodiments, the computing system 101 modifies the set of input classes 402 based on a sequence length threshold for the mixed model pipeline. The sequence length threshold, for example, may comprise an input size of the mixed model pipeline 428. The sequence length threshold may define a minimum and/or maximum number of elements in an input sequence 406 that the mixed model pipeline 428 is configured to process. In some examples, the sequence length threshold may comprise an integer value that determines the dimensionality of the input sequence 406. As described herein, the sequence length threshold may be used to shape the input data, either through truncation (e.g., input sequences longer than the threshold) and/or padding (e.g., for input sequences shorter than the threshold), to ensure a consistent length across input sequences for the mixed model pipeline 428.

In some embodiments, the sequence length threshold may be based on the prediction domain. By way of example, the sequence length threshold may be based on a statistical measure (e.g., maximum, minimum, mean, median) associated with a set of completed class sequences. As one example, in a domain in which a majority of class sequences observed in the data have 5 or less classes, the sequence length threshold may comprise three classes (X1, X2, X3) for an input layer of the mixed model pipeline 428 with the fourth class (Y1) used by the output layer of the mixed model pipeline 428. In the event that a target entity is associated with a sequence of defined classes that exceed the sequence length threshold, the sequence of defined classes may be divided into multiple input sequences that may be individually input to the mixed model pipeline 428.

In some examples, the computing system 101 may modify an input sequence 406 based on the sequence length threshold to prepare the input sequence 406 for an input layer of the mixed model pipeline 428.

For example, the computing system 101 may, responsive to a determination that a number of the set of input classes 402 exceeds the sequence length threshold, determine an input class subset from the input classes 402 based on the sequence length threshold and the set of elapsed time indicators 404. In such a case, the input class subset may be passed as the input sequence 406 to the mixed model pipeline 428. In this manner, the computing system 101 may truncate a set of input classes into an input class subset that is sized in accordance with the dimensions of the input layer of the mixed model pipeline 428.

In addition, or alternatively, responsive to a second determination that the number of the set of input classes 402 does not meet the sequence length threshold, the computing system 101 may determine a padded class set comprising (a) the set of input classes 402 and (b) one or more padded classes. In such a case, the padded class set may be passed as the input sequence to the mixed model pipeline. In this manner, the computing system 101 may pad a set of input classes to expand the set in accordance with the dimensions of the input layer of the mixed model pipeline 428.

In some embodiments, a padded class comprises a padded entry that is ignored by the mixed model pipeline 428. A padded class, for example, may comprise a placeholder used to standardize the length of input sequences 406. In some examples, the padded class may comprise a set of special tokens and/or values that is distinct from all valid class labels. This could be implemented as a reserved integer (e.g., 0) in the case of integer-encoded classes, as a vector of zeros in the case of one-hot encoded classes, and/or as a string for categorical classes. By way of example, a padded class may comprise the string "pad" while the elapsed time data for the padded class may comprise the numeric value ‘1000.0’. The mixed model pipeline 428 may be designed to recognize and ignore such padded entries through the use of masking operations as described in further detail herein.

In some embodiments, the computing system 101 generates, using the embedding layer 408 of the mixed model pipeline 428, a sequence of learned class embeddings 422 based on the set of input classes 402. For instance, the computing system 101 may generate the sequence of learned class embeddings 422 using a class embedding sublayer 410 of the embedding layer 408.

In some embodiments, the class embedding sublayer 410 is a portion of the embedding layer 408 that maintains and/or modifies an embedding lookup table to access a set of learned class embeddings that respectively correspond to a set of defined classes of a mixed prediction task. In some examples, the class embedding sublayer 410 may be configured to transform the set of input classes 402 of the input sequence 406 into a set of dense vector representations (e.g., learned class embeddings 422) that may be processed by subsequent layers of the mixed model pipeline 428. To do so, the class embedding sublayer 410 may comprise an embedding matrix, where each row corresponds to a defined class and comprises a learned class embedding for that class. The embedding matrix, for example, may be implemented as a lookup table to form the embedding lookup table. In some examples, the embedding lookup table may be configured to mask padded entries by creating a mask tensor which may be used by the concatenated embedding sublayer 414 to ignore the class or elapsed days data that has been padded with particular value (e.g., a class index of 0, an elapsed time indicator of 1000.0).

In some examples, the embedding lookup table may comprise a set of learned class embeddings indexed according to a set of class indices that respectively correspond to a set of defined classes. In some examples, the learned class embeddings may be initialized randomly and then updated during the training process through backpropagation. During inference, the class embedding sublayer 410 may map an input class to a class index of the embedding lookup table and based on the class index, replace the input class with a learned class embedding corresponding to the class index. In some examples, the class embedding sublayer 410 may encode an input class with the string “pad” (or any other padded class indicator) with a 0. In this manner, the class embedding sublayer 410 may be used at the beginning of an encoding process in the mixed model pipeline 428 to convert categorical input classes into dense vector representations. For example, when an input sequence 406 is processed, the class embedding sublayer 410 may replace up to each input class in the set of input classes 402 with a corresponding learned class embedding by looking up the appropriate row (e.g., based on the class index) in the embedding lookup table to generate the sequence of learned class embeddings 422. In this way, the class embedding sublayer 410 may transform discrete, categorical inputs into continuous vector representations that capture semantic relationships between different classes.

In some embodiments, a learned class embedding of the sequence of learned class embeddings 422 comprises a dense vector that encodes the semantic relationships of a defined class with respect to a set of defined classes. The learned class embedding may comprise a set number of dimensions (e.g., three, five, ten). In some examples, the number of dimensions in the learned class embeddings, for example, may comprise a hyperparameter that may be tuned based on the specific requirements of the task. Up to each of the set number of dimensions may be initially random values. As the mixed model pipeline 428 is trained, the embedding weights may be updated in order to reduce a total loss (e.g., classification loss, regression loss, aggregated loss) of the mixed model pipeline 428 and, by doing so, modify the learned class embeddings 422. In some examples, the learned class embeddings may be stored as a row in the embedding lookup table (e.g., represented as a vector of floating-point numbers), as described herein.

In some embodiments, the computing system 101 generates, using the embedding layer 408 of the mixed model pipeline 428, an input sequence embedding 424 for the input sequence 406 by concatenating the sequence of learned class embeddings 422 with the set of elapsed time indicators 404. For instance, the computing system 101 may generate the input sequence embedding 424 using a concatenation sublayer 412 of the embedding layer 408. The input sequence embedding 424, for example, may comprise a set of input embeddings. In some examples, an input embedding of the set of input embeddings may comprise a learned class embedding from the sequence of learned class embeddings 422 and one of the elapsed time indicators 404 that corresponds to the learned class embedding.

In some embodiments, the concatenation sublayer 412 comprises a portion of the embedding layer 408 that incorporates temporal data into a learned class embedding to create the input sequence embedding 424. To do so, the concatenation sublayer 412 concatenates an elapsed time indicator of an input class to a learned class embedding corresponding to the input class. In this manner, the concatenation sublayer 412 may generate an input embedding that synthesizes combining categorical and temporal information into a single, unified representation. The input embedding, for example, may comprise a multi-dimensional embedding that comprises a set of embedding dimensions (e.g., three embedding dimensions of a learned class embedding) representing an input class and a time dimension representing an elapsed time indicator corresponding to the input class. The concatenation sublayer 412 may generate an input embedding for up to each learned class embedding of the sequence of learned class embeddings 422 to generate the input sequence embedding 424.

In some embodiments, the computing system 101 generates, using the embedding layer 408 of the mixed model pipeline 428, a hidden state representation 426 of the input sequence 406 based on the input sequence embedding 424. For instance, the computing system 101 may generate the hidden state representation 426 using a concatenated embedding sublayer 414 of the embedding layer 408. In some examples, the hidden state representation 426 may be generated by a machine learned embedding model, such as a recurrent neural network, and/or the like.

In some embodiments, the concatenated embedding sublayer 414 comprises a portion of the embedding layer 408 that converts the input sequence embedding 424 to a hidden state representation 426 of the input sequence 406. The concatenated embedding sublayer 414, for example, may comprise a machine learned embedding model, such as a recurrent neural network, an LSTM, GRU, and/or the like that applies one or more neural network layers, gating mechanisms, and/or the like to the input sequence embedding 424 to generate a hidden state representation 426 that encodes relationships between the embedding and timing dimensions of up to each of the input embeddings of the input sequence embedding 424. The concatenated embedding sublayer 414, for example, may comprise a specialized model layer configured to handle the complex computations involved in processing sequences by maintaining an internal state that is updated as it processes each element of the input sequence embedding 424. The concatenated embedding sublayer 414, for example, may be configured to sequentially process up to each input embedding of the input sequence embedding 424 to capture temporal dependencies and create a compact representation (e.g., hidden state representation 426) of the entire sequence that may be passed to downstream layers of the mixed model pipeline 428. By way of example, the input sequence embedding 424 may be fed into the concatenated embedding sublayer 414 one timestep (e.g., input embedding) at a time. The concatenated embedding sublayer 414 may leverage a gating mechanism to control how much information of the input sequence embedding 424 flows through to the next sequence until a final hidden state representation 426 is generated.

In some embodiments, the hidden state representation 426 is an output of the embedding layer 408 that is passed to the decoding layer 416. The hidden state representation 426, for example, may comprise a shared state representation that may be passed to one or more decoder heads to simultaneously predict predictions of different data types. The hidden state representation 426 may comprise a compact, learned representation of the input sequence 406 that captures both the semantic and temporal aspects of the input sequence 406 that may be leveraged by up to each of the decoder heads within the decoding layer 416 of the mixed model pipeline 428. By way of example, the hidden state representation 426 may comprises a vector and/or tensor of floating-point numbers with the dimensions depending on the architecture of the decoding layer 416. For example, in an LSTM-based model, the hidden state representation may comprise two tensors: one for the cell state and one for the hidden state. The size of the tensors may be based on a hyperparameter that may be tuned based on the complexity of the task (and/or the size of the concatenated embedding sublayer 414). By way of example, the concatenated embedding sublayer 414 may comprise a set of neurons and the hidden state representation 426 may comprise a dimension for up to each of the set of neurons. In some examples, in a three neuron implementation, the hidden state representation 426 may comprise a three dimensional tensor of floating-point numbers.

As described herein, the hidden state representation 426 may comprise a single output of the embedding layer 408 that may serve as an input to a plurality of different decoding layers of the mixed model pipeline 428, such as the connected classification layer 418 and/or the connected regression layer 420 that generate the final aggregate output. By using the same hidden state representation 426 for a plurality of types of predictions, the mixed model pipeline 428 may ensure that both the classification and temporal aspects of the mixed prediction task may be based on the same underlying representation of the input sequence 406.

In some embodiments, the computing system 101 inputs the hidden state representation 426 to the decoding layer 416 of the mixed model pipeline 428 to generate an aggregate output for the input sequence 406. For instance, the computing system 101 may input the hidden state representation 426 to a connected classification layer 418 of the mixed model pipeline 428 to receive a class prediction 430 based on the hidden state representation 426. In addition, or alternatively, the computing system 101 may input the hidden state representation 426 to a connected regression layer 420 of the mixed model pipeline 428 to receive a time prediction 432 based on the hidden state representation 426.

In some embodiments, the connected classification layer 418 comprises a machine learned classification model that is trained to generate a classification from a hidden state representation 426 of an input sequence 406. The connected classification layer 418 is configured, trained, and/or the like, for decoding the hidden state representation 426 into one or more probabilistic outputs associated with at least one of the set of defined classes. By way of example, in a multi-classification use case, the connected classification layer 418 may provide a probability distribution over up to each of the set of defined classes.

The connected classification layer 418 may comprise a machine learning classifier, such as random forest, neural network, and/or the like, that is configured, trained, and/or the like to generate a discrete prediction from the hidden state representation 426 of an input sequence 406. The connected classification layer 418, for example, may comprise a fully connected (e.g., dense) neural network layer (and/or any other type of classifier) followed by a softmax activation function. By way of example, the connected classification layer 418 may comprise a weight matrix, one or more bias vectors, and/or the like that are learned during a training process to output one or more probabilistic outputs (e.g., probability distribution) from the hidden state representation 426. In the case of a probability distribution, the softmax activation function may ensure that the probabilities of the distribution sum to 1.

The connected classification layer 418 may comprise one of one or more decoding heads within a decoding layer 416 of the mixed model pipeline 428 that is specialized for a discrete (e.g.., binary, categorical) prediction. The connected classification layer 418 may receive the hidden state representation 426 produced by the embedding layer 408 as input and produce a probabilistic output corresponding to a discrete prediction. As described in further detail with reference to FIG. 6, the connected classification layer 418 may be trained, using a classification loss function, such as a sparse categorical cross entropy loss function, to improve the accuracy of the probabilistic output. In this manner, the connected classification layer 418 may be trained to decode the hidden state representation 426 in terms of a classification task by recognizing patterns in the hidden state representation 426 that are indicative of different output classes, allowing the model to make informed discrete predictions of a next occurrence of a defined class within the input sequence 406.

In some embodiments, the class prediction 430 is a defined class that is determined from the set of defined classes based on the output of the connected classification layer 418. In some examples, the class prediction 430 describes a defined class that is predicted to follow a last input class (e.g., the most recently occurring) of an input sequence 406. The connected classification layer 418, for example, may output one or more probabilistic values associated with one or more defined classes. In a single classification use case, the class prediction 430 may comprise a defined class associated with a probabilistic value that achieves a classification threshold (e.g., .5). In addition, or alternatively, in a multi-classification use case, the class prediction 430 may comprise a defined class that is associated with a highest probabilistic value from a probability distribution.

In some embodiments, the connected regression layer 420 comprises a machine learning regressor, such as a linear, logistic, polynomial, ridge, lasso, and/or the like, architecture that is configured, trained, and/or the like to generate a continuous prediction from a hidden state representation 426 of an input sequence 406. The connected regression layer 420, for example, may comprise a time series regression model configured to transform the hidden state representation 426 into a continuous value representing the predicted time until the next class in the input sequence 406.

The connected regression layer 420 may comprise one of one or more decoding heads within a decoding layer 416 of the mixed model pipeline 428 that is specialized for a continuous (e.g.., variable, unconstrained) prediction. The connected regression layer 420 may receive the hidden state representation 426 produced by the embedding layer 408 as input and produce a continuous output corresponding to the discrete prediction of the connected classification layer 418. As described in further detail with reference to FIG. 6, the connected regression layer 420 may be trained, using a regression loss function, such as a mean squared error function, to improve the accuracy of the continuous output. In this manner, the connected regression layer 420 may be trained to decode the hidden state representation 426 in terms of a regression task by recognizing patterns in the hidden state representation 426 that are indicative of a timing of a future class, allowing the model to make informed continuous predictions of a next occurrence of a defined class within the input sequence 406.

In some embodiments, the time prediction 432 comprise an elapsed time prediction that corresponds to a class prediction 430 and describes a predicted duration of time from a start point to the predicted occurrence of the class prediction 430. A time prediction 432, for example, may comprise a numerical value (e.g., seconds, minutes, days) that is consistent with the time units used for the elapsed time indicators in the input sequence 406. In this manner, the time prediction 432 may be combined with the class prediction 430 to incorporate the class prediction 430 within a predicted sequence of classes subsequent to the input sequence 406.

In some embodiments, the computing system 101 provides an aggregate output for the input sequence the identifies the class prediction 430 and the time prediction 432. The aggregate output, for example, may comprise the class prediction 430 and the time prediction 432 such that it combines predictions of different data types (e.g., categorical and discrete versus continuous and unconstrained) into a single, comprehensive output that describes both a predicted class and a timing of the occurrence of the predicted class. In this way, the mixed model pipeline 428 may generate predictions for both a next defined class and the timing of the next defined class within the input sequence 406.

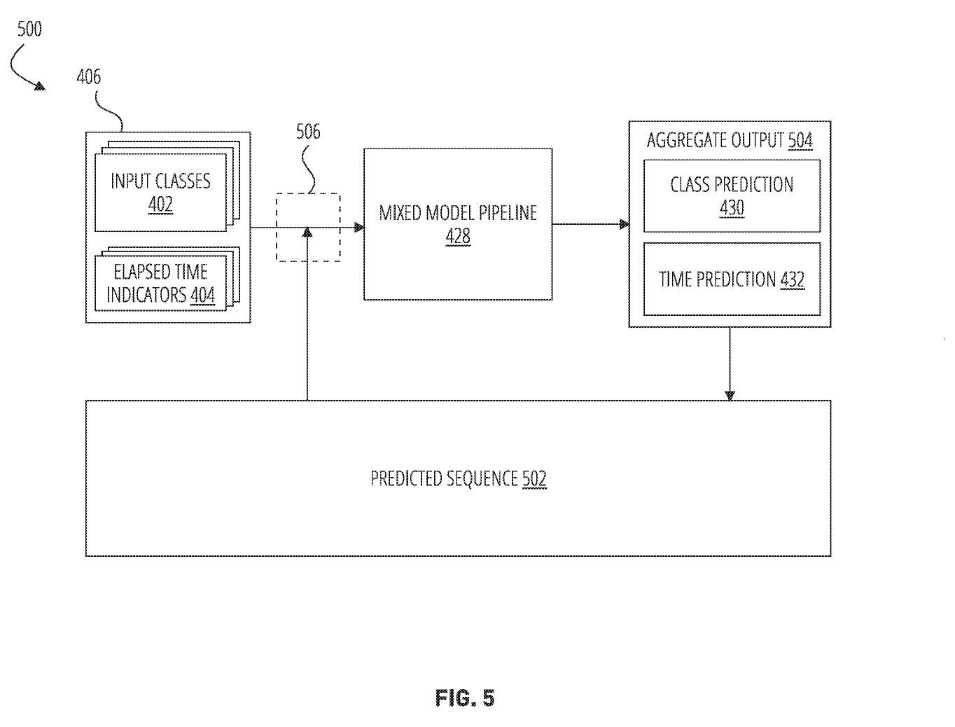

In some examples, the computing system 101 may generate a predicted sequence based on the aggregate output. For example, as described in further detail with reference to FIG. 5, through one or more iterations, the computing system 101 may iteratively generate new aggregate outputs for subsequent time steps into the future by feeding the aggregate outputs as additional inputs to the mixed model pipeline 428. In this way, the mixed model pipeline 428 may be executed on previously generated insights to sequentially generate insights further into the future. At each iteration, a new aggregate output may be generated and added to a sequence of aggregate outputs within a predicted sequence. This iterative prediction scheme is described more fully with reference to FIG. 5.

FIG. 5 depicts a dataflow diagram 500 of an iterative prediction scheme in accordance with some embodiments of the present disclosure. The iterative prediction scheme may leverage the mixed model pipeline 428 to iteratively generate a predicted sequence 502 from the input sequence 406 by concatenating aggregate outputs 504 of the mixed model pipeline 428 to the input sequence 406 to iteratively generate next-iteration input sequences 506 that incorporate the insights of the mixed model pipeline 428. Through a series of iterations, the iterative prediction scheme may incrementally expand the predictive capabilities of the mixed model pipeline 428 to future time periods until a stopping condition is detected. In some examples, the stopping condition may be tailored to one of a plurality of component predictions of an aggregate output 504. In this way, the iterative prediction scheme may enable sequential predictions for mixed prediction tasks, while retaining the prediction granularity required to allow for stopping conditions tailored to particular portions of the mixed prediction task. In some examples, the computing system 101 may perform the iterative prediction scheme on a prediction interval to continuously update a predicted sequence 502 based on new information (e.g., by replacing an aggregate output 504 with an observed output and re-executing the mixed model pipeline 428).

In some embodiments, the predicted sequence 502 is a sequence of aggregate outputs 504 that is generated during a plurality of prediction iterations. The predicted sequence 502 may be generated by the mixed model pipeline 428 through an iterative prediction scheme that combines classification and temporal predictions to produce a series of outputs over multiple iterations. In practice, the predicted sequence 502 may be used to forecast future events or states in a sequential process. For instance, in a clinical domain, such as the COB use case described herein, the predicted sequence 502 may represent a series of predicted COB stages and corresponding elapsed times for a medical claim's lifecycle, with up to each element in the predicted sequence 502 comprising a next COB stage and an elapsed time before the COB stage. In another example, in a network security domain, such as the network attack tracking use case described herein, the predicted sequence 502 may represent a series of predicted attack signatures and corresponding elapsed times for the duration of the attack, with up to each element in the predicted sequence 502 comprising a next attack signature and an elapsed time before the attack signature. In this way, the predicted sequence 502 may provide a comprehensive view of potential future outcomes for any domain based on an initial input sequence 406 of a limited set of observed classes. Thus, instead of limiting the predictive process to a class immediately following the initial sequence, the iterative prediction scheme may expand the predicted sequence 502 to the lifetime of a target entity as defined by a stopping condition.

In some embodiments, a stopping condition comprises a terminating class condition and/or an iteration condition. The terminating class condition, for example, may terminate the iterative prediction scheme in response to a match between a class prediction 430 and one of one or more terminating classes. For example, with respect to the terminating class condition, the computing system 101 may, responsive to a match between the class prediction 430 and a terminating class, provide the aggregate output 504 as at least a portion of a predicted sequence 502. In addition, or alternatively, the computing system 101 may, responsive to a mismatch between the class prediction 430 and the terminating class, (i) concatenate the aggregate output 504 to the input sequence 406 to generate a next-iteration input sequence 506 and (ii) generate a next-iteration aggregate output based on the next-iteration input sequence 506.

In some embodiments, a terminating class comprises one or more of the set of defined classes that represents an end of a lifecycle for a target entity. A terminating class may depend on the mixed prediction task. For example, in the COB use case of the present disclosure, a claim may terminate after a recovery or closure COB state and, in such a case, the terminating class may comprise a recovery class and/or the closure class. As another example, in the network attack use case of the present disclosure, a network attack investigation may terminate after a vulnerability is patched and, in such a case, the terminating class may comprise a patched vulnerability class. In any domain, the terminating class may serve as an endpoint in a sequential prediction task that may trigger the termination of a predicted sequence 502.

The iteration condition, for example, may terminate the iterative prediction scheme in response to a number of iterations meeting or exceeding an iteration threshold. In some embodiments, the iteration threshold comprises a maximum sequence length of a predicted sequence that defines a max number of iterations of the mixed model pipeline 428. The iteration threshold may serve as a safeguard in sequential prediction tasks to prevent the generation of excessively long sequences that may be computationally expensive or unrealistic in the context of the problem domain. By way of example, the iteration threshold may define a maximum sequence length fifteen that may reduce the maximum number of iterations to twelve (e.g., the three input classes in addition to twelve aggregate outputs).

In some examples, the iteration threshold may comprise a hyperparameter that may be modified based on an accuracy of the mixed model pipeline 428. For instance, the computing system 101 may monitor a performance drop of the mixed model pipeline 428 at each iteration of a predicted sequence 502 (e.g., as ground truth observations are received). The computing system 101 may dynamically set the iteration threshold based on a comparison between an overall performance drop and a performance threshold (e.g., -20%) of the mixed model pipeline 428.

In some embodiments, the computing system 101 performs a next iteration of a sequential prediction process by generating a next-iteration input sequence 506 and inputting the next-iteration input sequence 506 to the mixed model pipeline 428. For example, a first subset of classes (e.g., a first three classes, a first four classes) for a target entity may be fed, as the input sequence 406, to the mixed model pipeline 428 at a first iteration of the sequential prediction process to generate the aggregate output 504 (e.g., a fourth class, fifth class). Thereafter, a next-iteration input sequence 506 may be generated that comprises a most recent portion of the first subset of classes (e.g., the second and third classes or the second, third, and fourth classes) from the input sequence 406 and the aggregate output 504. The next-iteration input sequence 506 (e.g., the second class, third class, and aggregate output 504 or the second class, third class, fourth class, and aggregate output 504) may be fed to the mixed model pipeline 428 at a second iteration of the sequential prediction process to generate the next-iteration aggregate output (e.g., a fifth class, sixth class). This process may continue until a stopping condition is reached and, at each iteration, the predicted sequence 502 may be modified with an aggregate output 504 to generate a sequence of aggregate outputs for a target entity.

FIG. 6 depicts a dataflow diagram 600 of a mixed training scheme in accordance with some embodiments of the present disclosure. As depicted, the mixed training scheme may combine traditionally incompatible machine learning loss metrics within a single dual loss function 612. By doing so, the mixed training scheme allows for the integration of disparate machine learning architectures within a single model pipeline with a shared embedding layer 408. By jointly optimizing both a classification loss 608 and a regression loss 610, the mixed training scheme improves the predictive accuracy of any resulting model by synthesizing corrective insights from traditionally incompatible training approaches. This, in turn, leads to improved machine learning models and may reduce the training time of machine learning models with respect to mixed prediction tasks.

In some embodiments, one or more of the embedding lookup table, the machine learned embedding model of the concatenated embedding sublayer 414, the connected classification layer 418, and/or the connected regression layer 420 of the mixed model pipeline 428 are jointly trained based on a dual loss function 612 that determines a classification loss 608 for the connected classification layer 418 and/or a regression loss 610 for the connected regression layer 420.

In some embodiments, the dual loss function 612 comprises a loss function configured to evaluate the performance of the mixed model pipeline 428 with respect to multiple outputs of different data types. The dual loss function 612, for example, may comprise loss functions configured to generated metrics for both classification (e.g., discrete categorical output types) and regression (e.g., continuous output types) models. The loss functions, for example, may comprise a classification loss function configured to generate a classification loss 608 from the outputs of the connected classification layer 418 and/or a regression loss function configured to generate a regression loss 610 from the outputs of the connected regression layer 420. By combining both loss functions, the dual loss function 612 may enable the simultaneous training of the connected classification layer 418 and/or the connected regression layer 420 to simultaneously predict outputs of different data types, as needed in mixed prediction tasks. In this manner, the computing system 101 may leverage the dual loss function 612 during training to balance and optimize multiple prediction objectives simultaneously.

In some embodiments, the classification loss 608 comprises one of one or more outputs from the dual loss function 612 that represents a classification loss metric, such as a sparse categorical cross entropy loss, binary cross-entropy, focal loss, and/or the like. The classification loss 608, for example, may quantify the error in a mixed model pipeline's classification predictions, such as in the context of a machine learning model that outputs probabilities over a set of defined classes. The classification loss 608 may be generated using a classification loss function of the dual loss function 612. By way of example, for a sparse categorical cross entropy loss, the classification loss function may determine the negative log likelihood of a true class (e.g., class label 604) given a predicted probability distribution output from the connected classification layer 418.

In some embodiments, the computing system 101 trains the mixed model pipeline 428 using the classification loss 608. For example, the computing system 101 may determine the classification loss 608 (e.g., the sparse categorical cross entropy) based on a comparison between the probabilistic output (e.g., probabilistic value, probability distribution) of the connected classification layer 418 and the class label 604 (e.g., ground truth value (Y1)) to determine an error of the mixed model pipeline 428 with respect to the classification portion of the mixed model pipeline's mixed functionality. This error may be backpropagated through the mixed model pipeline 428 by updating (i) the learned class embeddings of the embedding lookup table of the class embedding sublayer 410, (ii) the weights applied to the embeddings based on time features by the concatenated embedding sublayer 414, and/or the learned weighting matrices of the connected classification layer 418. In this manner, the mixed model pipeline 428 may be trained end to end based on the classification loss 608.

In some embodiments, the computing system 101 jointly trains the portions of the mixed model pipeline 428. In addition, or alternatively, the computing system 101 may train the mixed model pipeline 428 over one or more training stages. At a first stage, the learnable parameters, weights, coefficients, and/or the like, of the embedding layer 408 may be frozen and the connected classification layer 418 may be trained. As a second stage, the learnable parameters, weights, coefficients, and/or the like, of the decoding layer 416 may be frozen and at least one of the class embedding sublayer 410 and/or concatenated embedding sublayer 414 may be trained. In some cases, the learnable parameters, weights, coefficients, and/or the like, of the class embedding sublayer 410 may be frozen during the second stage and the concatenated embedding sublayer 414 may be trained. In addition, or alternatively, at a third stage, the learnable parameters, weights, coefficients, and/or the like, of the concatenated embedding sublayer 414 may be frozen and the class embedding sublayer 410 may be trained. In some examples, the computing system 101 may iteratively cycle through a first, second, and/or third stage until the mixed model pipeline 428 achieves an optimization threshold with respect to the classification functionality of the mixed model pipeline 428.

In some embodiments, the regression loss 610 comprises one of one or more outputs from the dual loss function 612 that represents a regression loss metric, such as a mean squared error, root mean squared error, mean absolute error, and/or the like. The regression loss 610, for example, may quantify the error in the mixed model pipeline's continuous-valued predictions, such as in the context of a machine learning model that outputs numerical estimates. The regression loss 610 may be generated using a regression loss function of the dual loss function 612. By way of example, for mean squared error, the regression loss function may determine an average of the squared differences between a time prediction 432 and a time label 606.

In some embodiments, the computing system 101 trains the mixed model pipeline 428 using the regression loss 610. For example, the computing system 101 may determine the regression loss 610 (e.g., the mean squared error) based on a comparison between a continuous output of the connected regression layer 420 and the time label 606 (e.g., ground truth value (Y1) for elapsed days) to determine an error of the mixed model pipeline 428 with respect to the regression portion of the mixed model pipeline's mixed functionality. This error may be backpropagated through the mixed model pipeline 428 by updating (i) the learned class embeddings of the embedding lookup table of the class embedding sublayer 410, (ii) the weights applied to the embeddings based on time features by the concatenated embedding sublayer 414, and/or the learned weighting matrices of the connected regression layer 420. In this manner, the mixed model pipeline 428 may be trained end to end based on the regression loss 610.

In some embodiments, the computing system 101 jointly trains the portions of the mixed model pipeline 428. In addition, or alternatively, the computing system 101 may train the mixed model pipeline 428 over one or more training stages. At a first stage, the learnable parameters, weights, coefficients, and/or the like, of the embedding layer 408 may be frozen and the connected classification layer 418 may be trained. As a second stage, the learnable parameters, weights, coefficients, and/or the like, of the decoding layer 416 may be frozen and at least one of the class embedding sublayer 410 and/or concatenated embedding sublayer 414 may be trained. In some cases, the learnable parameters, weights, coefficients, and/or the like, of the class embedding sublayer 410 may be frozen during the second stage and the concatenated embedding sublayer 414 may be trained. In addition, or alternatively, at a third stage, the learnable parameters, weights, coefficients, and/or the like, of the concatenated embedding sublayer 414 may be frozen and the class embedding sublayer 410 may be trained. In some examples, the computing system 101 may iteratively cycle through a first, second, and/or third stage until the mixed model pipeline 428 achieves an optimization threshold with respect to the regression functionality of the mixed model pipeline 428.

In some embodiments, the classification loss 608 and/or regression loss 610 are determined using supervised training loss functions based on a comparison between a training label 602 and a class prediction 430 or time prediction 432 of the mixed model pipeline 428. The training label 602, for example, may comprise a class label 604 and/or time label 606 that describe a ground truth observation of the occurrence and timing of a defined class following an input sequence 406. For example, during training, a set of training entries may be generated by dividing observed class sequences into a set of training inputs and training labels. A training input may comprise a segment (e.g., a set of input classes) of the class sequence that aligns with the sequence length threshold of the mixed model pipeline 428. A training label 602 for the training input may comprise a defined class (e.g., a class label 604) and elapsed time indicator (e.g., time label 606) that immediately follows the segment (e.g., a set of input classes) of the class sequence. In this manner, a set of class sequences may be expanded into a robust training dataset for the mixed model pipeline 428.

In some examples, one or more of the embedding lookup table, the machine learned embedding model, the connected classification layer 418, and/or the connected regression layer 420 are trained based on an aggregated loss (not depicted) that combines the classification loss 608 and the regression loss 610. The aggregated loss may be determined by: (i) applying a first scaling factor to the classification loss 608 to determine a scaled classification loss, (ii) applying a second scaling factor to the regression loss 610 to determine a scaled regression loss, and (iii) aggregating the scaled classification loss with the scaled regression loss to determine the aggregated loss.

In some embodiments, the aggregated loss comprises a scaled combination of the classification loss 608 and regression loss 610. The aggregated loss, for example, may comprise a weighted sum and/or other combination of the individual classification loss 608 and/or regression loss 610 components of the dual loss function 612. For example, the computing system 101 may generate the aggregated loss by applying a first scaling factor to the classification loss 608 and/or a second scaling factor to the regression loss 610 to cover loss metrics of different scales into a universal scale. In this manner, the aggregated loss may balance two, distinct loss metrics to ensure that neither dominates the other during training. By doing so, the aggregated loss may form a primary optimization objective for simultaneously improving the accuracy of the mixed model pipeline 428 with respect to distinct prediction tasks of a mixed prediction task. For example, for each training example and/or batch, the dual loss function 612 may determine both the classification loss 608 and the regression loss 610 based on an aggregate output, combine the individual losses into the aggregated loss to provide a single scalar value representing the model's overall performance on both tasks, and then train one or more components of the mixed model pipeline 428 to improve (e.g., reduce or increase depending on the metric) the aggregated loss.

In some embodiments, the first scaling factor comprises a hyperparameter used to covert the classification loss 608 into a numerical range of the regression loss 610. The first scaling factor, for example, may comprise a scaling coefficient that may be applied to the classification loss 608 to convert the classification loss 608 into a scaled classification loss within the same value range of the regression loss 610. For example, if the classification loss 608 (e.g., categorical cross-entropy) produces a values in the range of 0 to 1, while the regression loss 610 (e.g., mean squared error) produces a value in the range of 0 to 100, a first scaling factor of 100 may be applied to the classification loss 608 to bring it into a comparable range with the regression loss 610.

In some embodiments, the second scaling factor comprises a hyperparameter used to covert the regression loss 610 into a numerical range of the classification loss 608. The second scaling factor, for example, may comprise a scaling coefficient that may be applied to the regression loss 610 to convert the regression loss 610 into a scaled regression loss within the same value range of the classification loss 608. For example, if the regression loss 610 (e.g., mean squared error) produces a values in the range of 0 to 100, while the classification loss 608 (e.g., categorical cross-entropy) produces a value in the range of 0 to 1, a second scaling factor of 0.01 may be applied to the regression loss 610 to bring it into a comparable range with the classification loss 608.

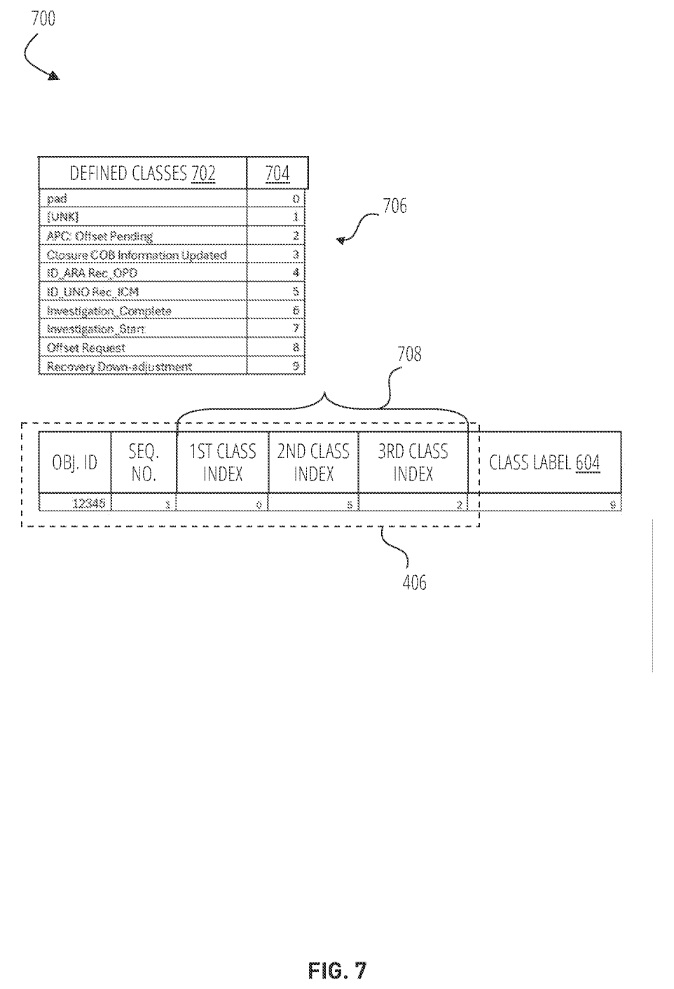

FIG. 7 depicts an operational example 700 of an indexing stage of a class embedding sublayer in accordance with some embodiments of the present disclosure. As shown, the class embedding sublayer may comprise an embedding lookup table 706 that defines a set of defined classes 702 indexed by class index 704. During the indexing stage, the class embedding sublayer may perform a string comparison (e.g., exact string match, fuzzy match) between an input class and the set of defined classes 702 to determine a class index 704 for the input class. The class embedding sublayer may replace the input class with the class index 704 within the input sequence 406 to convert the string values of the input sequence 406 into a set of numerical indices. By way of example, at the indexing stage, the class embedding sublayer may replace up to each of the set of input classes of the input sequence 406 with their respective class indices 704 to generate an input sequence 406 that comprises a set of class indices 708. Through the operations of the present disclosure, the set of class indices 708 may be combined with elapsed time indicators to generate a class prediction for a future defined class following the sequence of defined classes identified by the set of class indices 708. As described herein, the class prediction may be generated by training the mixed model pipeline using one or more training labels. By way of example, in a training phase, the set of class indices 708 may be followed by a class label 604 (e.g., corresponding to the class index “9”) that identifies an observed defined class occurring subsequent to the set of class indices 708.

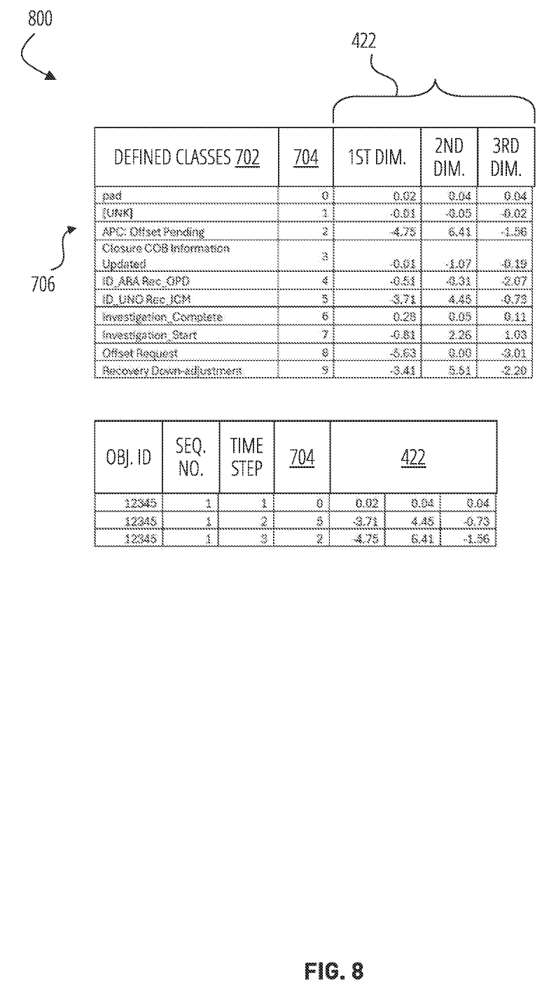

FIG. 8 depicts an operational example 800 of an embedding stage of a class embedding sublayer in accordance with some embodiments of the present disclosure. As shown, the class embedding sublayer may comprise an embedding lookup table 706 that defines a set of defined classes 702 indexed by class index 704. In addition, or alternatively, the embedding lookup table 706 may comprise a learned class embedding 422 for up to each of the class index 704. In this manner, a class index 704 may service as an intermediary between a string-based input class and a learned class embedding corresponding to the input class. In the operational example 800, up to each of the learned class embeddings 422 may comprise a three-dimensional embedding; however, any number of embedding dimensions may be used based on the complexity of the mixed prediction task. During the embedding stage, the class embedding sublayer may perform an index lookup to replace the class indices of a numerical input sequence with their respective learned class embeddings 422. By way of example, at the embedding stage, the class embedding sublayer may replace up to each of a set of class indices of the numerical input sequence 406 with their respective learned class embeddings 422 to generate a set of learned class embeddings 422.

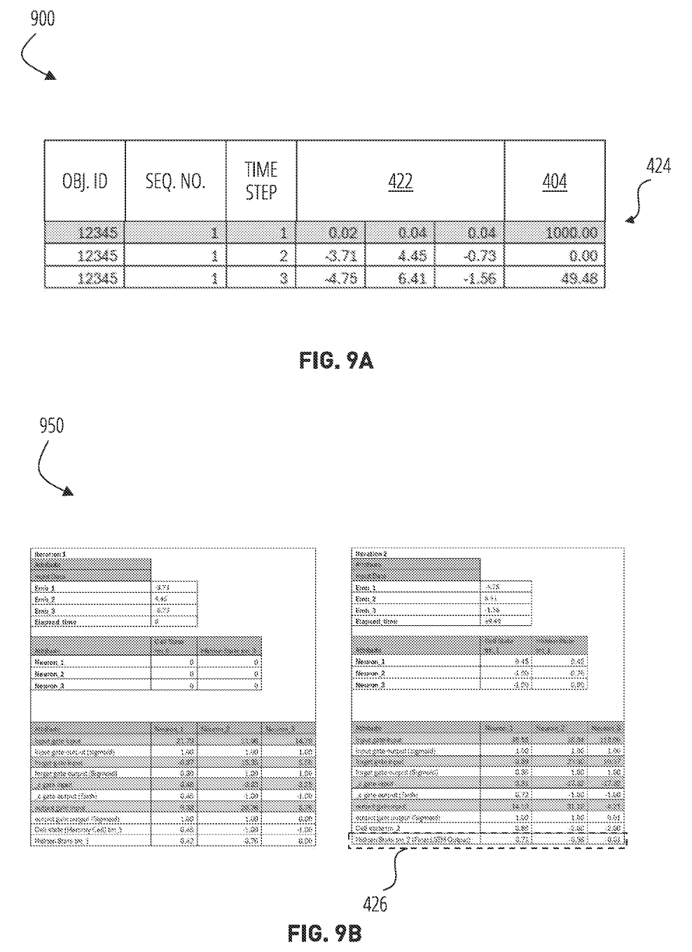

FIGS. 9A-B depict operational examples of a concatenation sublayer and concatenated embedding sublayer in accordance with some embodiments of the present disclosure.

FIG. 9A, for example, depicts an operational example 900 of a concatenation sublayer. As shown, the concatenation sublayer may concatenate a set of learned class embeddings 422 for up to each of a set of input classes of an input sequence with the set of elapsed time indicators 404 associated with the set of input classes. By way of example, a first input class (e.g., at time step 1) may correspond to a first learned class embeddings 422 (e.g., 0.02, 0.04, 0.04) and a first elapsed time indicator (e.g., 1000.00). The concatenation sublayer may concatenate the first learned class embeddings 422 with the first elapsed time indicator to generate a first input embedding corresponding to the first input class. The concatenation sublayer may repeat this process for up to each input class of an input sequence to generate the input sequence embedding 424.

FIG. 9B depicts an operational example 950 of the example operations of the concatenated embedding sublayer. As shown, the concatenated embedding sublayer may perform a series of gating (e.g., input, forget, output) functions to selectively pass information from one or more input embeddings of the input sequence embedding 424 to a subsequent embedding layer until a hidden state representation 426 is generated that represents up to each of the input embeddings within a single vector.

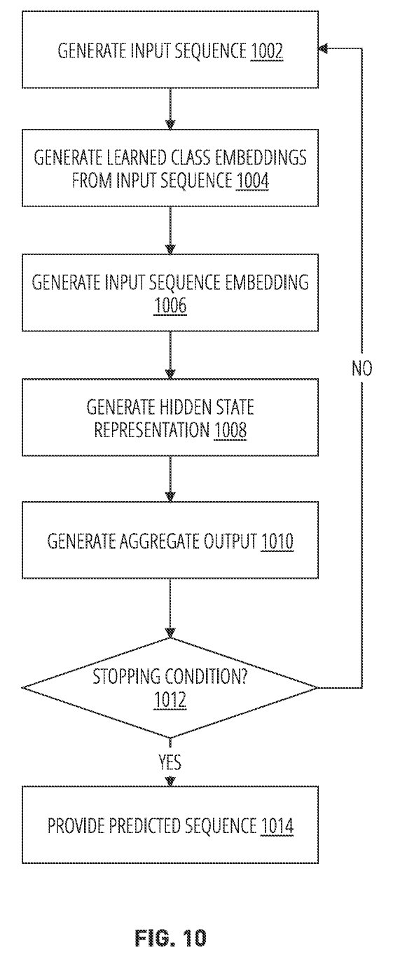

FIG. 10 depicts a flowchart diagram of a sequential prediction process 1000 in accordance with some embodiments of the present disclosure. The flowchart diagram depicts a sequential prediction process 1000 that leverages a new mixed model architecture to generate sequential predictions for a mixed prediction task. The process 1000 may be implemented by one or more computing devices, entities, and/or systems described herein. For example, via the various steps/operations of the process 1000, the computing system 101 may apply the mixed model architecture to jointly predict a class prediction and a time prediction for up to each of a set of sequential prediction iterations. By doing so, the process 1000 improves machine learning technology by enabling sequential predictions for a mixed prediction task by a single model architecture. By using a single model architecture, the sequential prediction process 1000 improves the prediction accuracy, training speeds, and inference speeds of the computing system 101 relative to traditional machine learning approaches.

FIG. 10 illustrates an example process 1000 for explanatory purposes. Although the example process 1000 depicts a particular sequence of steps/operations, the sequence may be altered without departing from the scope of the present disclosure. For example, some of the steps/operations depicted may be performed in parallel or in a different sequence that does not materially impact the function of the process 1000. In other examples, different components of an example device or system that implements the process 1000 may perform functions at substantially the same time or in a specific sequence.

In some embodiments, the process 1000 comprises, at operation 1002, generating an input sequence. For example, the computing system 101 may receive and/or generate an input sequence comprising a set of input classes and a set of elapsed time indicators respectively corresponding to the set of input classes. In some examples, the computing system 101 may, responsive to a first determination that a number of the set of input classes exceeds a sequence length threshold, determine an input class subset from the input classes based on the sequence length threshold and the set of elapsed time indicators. In such a case, the input class subset may be passed as the input sequence to the mixed model pipeline. In addition, or alternatively, responsive to a second determination that the number of the set of input classes does not meet the sequence length threshold, the computing system 101 may determine a padded class set comprising (a) the set of input classes and (b) one or more padded classes. In such a case, the padded class set may be passed as the input sequence to the mixed model pipeline.

In some embodiments, the process 1000 comprises, at operation 1004, generating one or more learned class embeddings from the input sequence (e.g., original input sequence, an input class subset, padded class set). For example, the computing system 101 may generate, using an embedding layer of a mixed model pipeline, a sequence of learned class embeddings based on the set of input classes.

In some embodiments, the process 1000 comprises, at operation 1006, generating an input sequence embedding from the one or more learned class embeddings. For example, the computing system 101 may generate, using the embedding layer of the mixed model pipeline, an input sequence embedding for the input sequence by concatenating the sequence of learned class embeddings with the set of elapsed time indicators. For example, the input sequence embedding for the input sequence may comprise a set of input embeddings and an input embedding of the set of input embeddings may comprise a learned class embedding from the sequence of learned class embeddings and an elapsed time indicator corresponding to the learned class embedding.

In some embodiments, the process 1000 comprises, at operation 1008, generating a hidden state representation for the input sequence embedding. For example, the computing system 101 may generate, using the embedding layer of the mixed model pipeline, a hidden state representation of the input sequence based on the input sequence embedding. In some examples, the hidden state representation 426 may be generated by a machine learned embedding model, such as a recurrent neural network, and/or the like.

In some embodiments, the process 1000 comprises, at operation 1010, generating an aggregate output based on the hidden state representation. For example, the computing system 101 may input the hidden state representation to (i) a connected classification layer of the mixed model pipeline to receive a class prediction based on the hidden state representation and/or (ii) a connected regression layer of the mixed model pipeline to receive a time prediction based on the hidden state representation. In some examples, one or more of the machine learned embedding model, the connected classification layer, and/or the connected regression layer are jointly trained based on a dual loss function that determines a classification loss for the connected classification layer and/or a regression loss for the connected regression layer. The classification loss may comprise a sparse categorical cross entropy loss and/or the regression loss may comprise a mean squared error loss.

In some examples, at least one of the machine learned embedding model, the connected classification layer, and/or the connected regression layer may be trained based on an aggregated loss that combines the classification loss and the regression loss. The aggregated loss may be determined by: (i) applying a first scaling factor to the classification loss to determine a scaled classification loss, (ii) applying a second scaling factor to the regression loss to determine a scaled regression loss, and (iii) aggregating the scaled classification loss with the scaled regression loss to determine the aggregated loss.

In some embodiments, the process 1000 comprises, at operation 1012, determining whether a stopping condition is reached. In response to reaching the stopping condition, the computing system 101 may proceed to operation 1014. Otherwise, the computing system 101 may return to operation 1002 at which the computing system 101 may regenerate the input sequence based on the aggregate output and perform a subsequent iteration of the process 1000 based on the regenerated input sequence. For example, in response to reaching a stopping condition, the computing system 101 may provide the aggregate output for the input sequence that identifies the class prediction 430 and the time prediction 432 as a portion of a predicted sequence. In addition, or alternatively, the computing system 101 may provide the aggregate output for the input sequence that identifies the class prediction 430 and the time prediction 432 as a portion of a next-iteration input sequence.

In some examples, the stopping condition may comprise a terminating class condition and/or an iteration condition. The terminating class condition, for example, may terminate the process 1000 (e.g., by proceeding to operation 1014) in response to a match between a class prediction and one of one or more terminating classes. The iteration condition, for example, may terminate the process 1000 (e.g., by proceeding to operation 1014) in response to a number of iterations meeting or exceeding an iteration threshold.

For example, with respect to the terminating class condition, the computing system 101 may, responsive to a match between the class prediction and a terminating class, provide the aggregate output as at least a portion of a predicted sequence at operation 1014. In addition, or alternatively, the computing system 101 may, responsive to a mismatch between the class prediction and the terminating class, (i) concatenate the aggregate output to the input sequence to generate a next-iteration input sequence at operation 1002 and (ii) generate a next-iteration aggregate output based on the next-iteration input sequence.

In some embodiments, the process 1000 comprises, at operation 1014, providing a predicted sequence. For example, the computing system 101 may provide a predicted sequence to one or more downstream computing entities.

Some techniques of the present disclosure enable the generation of action outputs that may be performed to initiate one or more real world actions to achieve real-world effects. The techniques of the present disclosure may be used, applied, and/or otherwise leveraged to generate sequential outputs. In some examples, the sequential outputs of the present disclosure may trigger action outputs (e.g., through control instructions) to automate various action depending on the domain, such as network security actions, and/or the like. The action outputs may control various aspects of a client device, such as the display, transmission, and/or the like of data reflective of an alert, and/or the like. The alert may be automatically communicated to a user and/or may be used to initiate a security protocol (e.g., locking a computer), a robotic action (e.g., performing an automated screening process), and/or the like.

In some examples, the computing tasks may comprise actions that may be based on a particular domain. A domain may comprise any environment in which computing systems may be applied to interpret, store, and process data and initiate the performance of computing tasks responsive to the data. These actions may cause real-world changes, for example, by controlling a hardware component, providing alerts, interactive actions, and/or the like. For instance, actions may comprise the initiation of automated instructions across and between devices, automated notifications, automated scheduling operations, automated precautionary actions, automated security actions, automated data processing actions, and/or the like.

### Conclusion

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components comprise a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components may provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and may operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions comprise routines, programs, objects, components, data structures, and the like that perform particular functions or implement particular data types. The order in which the operations are described is not intended to be construed as a limitation, and any number of the described operations may be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These comprise physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is comprised in at least one embodiment, but not every embodiment necessarily comprises the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “comprises,” “including,” “has,” “having” or any other variation thereof, are intended to cover a non-exclusive inclusion. For example, a process, method, article, or apparatus that comprises a list of elements is not necessarily limited to only those elements but may comprise other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and may be a null set (i.e., a set containing zero elements) or may comprise one, two, or more elements. A “subset” is intended to mean a collection of elements that are all elements of a set, but that does not comprise other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” may be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations may encompass implementations in which performance of the operations is divided among the processor(s) in any suitable way. For example, “generating, by one or more processors, X; and generating, by the one or more processors, Y” may encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine learning model,” “machine-learning model,” “machine-learned component”, “artificial intelligence”, “artificial intelligence component”), or species thereof (e.g., “a large language model”, “a neural network”) may comprise a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model’s architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters(e.g., for unsupervised machine-learned models).

In some examples, structural hyperparameter(s) may define component(s) of the model’s architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may comprise a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may comprise any type of model configured, trained, and/or the like to generate a prediction output for a model input. In some examples, any of the logic, component(s), routines, and/or the like discussed herein may be implemented as a machine-learned model.

The machine-learned model may comprise one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model’s parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

### Examples

Some embodiments of the present disclosure may be implemented by one or more computing devices, entities, and/or systems described herein to perform one or more example operations, such as those outlined below. The examples are provided for explanatory purposes. Although the examples outline a particular sequence of steps/operations, each sequence may be altered without departing from the scope of the present disclosure. For example, some of the steps/operations may be performed in parallel or in a different sequence that does not materially impact the function of the various examples. In other examples, different components of an example device or system that implements a particular example may perform functions at substantially the same time or in a specific sequence.

Moreover, although the examples may outline a system or computing entity with respect to one or more steps/operations, each step/operation may be performed by any one or combination of computing devices, entities, and/or systems described herein. For example, a computing system may comprise a single computing entity that is configured to perform the steps/operations of a particular example. In addition, or alternatively, a computing system may comprise multiple dedicated computing entities that are respectively configured to perform one or more of the steps/operations of a particular example. By way of example, the multiple dedicated computing entities may coordinate to perform the steps/operations of a particular example.

Example 1. A computer-implemented method comprising receiving, by one or more processors, an input sequence comprising a set of input classes and a set of elapsed time indicators respectively corresponding to the set of input classes; generating, by the one or more processors and using an embedding layer of a mixed model pipeline, a sequence of learned class embeddings based on the set of input classes; generating, by the one or more processors and using the embedding layer of the mixed model pipeline, an input sequence embedding for the input sequence by concatenating the sequence of learned class embeddings with the set of elapsed time indicators; generating, by the one or more processors and using the embedding layer of the mixed model pipeline, a hidden state representation of the input sequence based on the input sequence embedding; inputting, by the one or more processors, the hidden state representation to (i) a connected classification layer of the mixed model pipeline to receive a class prediction based on the hidden state representation and (ii) a connected regression layer of the mixed model pipeline to receive a time prediction based on the hidden state representation; and providing, by the one or more processors, an aggregate output for the input sequence that identifies the class prediction and the time prediction.

Example 2. The computer-implemented method of example 1, further comprising, responsive to a match between the class prediction and a terminating class, providing the aggregate output as at least a portion of a predicted sequence.

Example 3. The computer-implemented method of any of the preceding examples, further comprising, responsive to a mismatch between the class prediction and a terminating class, (i) concatenating the aggregate output to the input sequence to generate a next-iteration input sequence and (ii) generating a next-iteration aggregate output based on the next-iteration input sequence.

Example 4. The computer-implemented method of any of the preceding examples, further comprising responsive to a first determination that a number of the set of input classes exceeds a sequence length threshold, (i) determining an input class subset from the set of input classes based on the sequence length threshold and the set of elapsed time indicators and (ii) generating the sequence of learned class embeddings based on the input class subset; or responsive to a second determination that the number of the set of input classes does not meet the sequence length threshold, (i) determining a padded class set comprising (a) the set of input classes and (b) a padded class and (ii) generating the sequence of learned class embeddings based on the padded class set.

Example 5. The computer-implemented method of any of the preceding examples, wherein the connected classification layer and the connected regression layer of the mixed model pipeline are jointly trained based on a dual loss function that determines a classification loss for the connected classification layer and a regression loss for the connected regression layer.

Example 6. The computer-implemented method of example 5, wherein the classification loss comprises a sparse categorical cross entropy loss and the regression loss comprises a mean squared error loss.

Example 7. The computer-implemented method of examples 5 or 6, wherein the hidden state representation is generated by a machine learned embedding model, and one or more of the machine learned embedding model, the connected classification layer, or the connected regression layer are jointly trained.

Example 8. The computer-implemented method of example 7, wherein the machine learned embedding model comprises a recurrent neural network.

Example 9. The computer-implemented method of examples 7 or 8, wherein at least one of the machine learned embedding model, the connected classification layer, or the connected regression layer is trained based on an aggregated loss that combines the classification loss and the regression loss.

Example 10. The computer-implemented method of any of the preceding examples, wherein the input sequence embedding for the input sequence comprises a set of input embeddings and an input embedding of the set of input embeddings comprises a learned class embedding from the sequence of learned class embeddings and an elapsed time indicator corresponding to the learned class embedding.

Example 11. A system comprising one or more processors; and one or more memories storing processor-executable instructions that, when executed by the one or more processors, cause the one or more processors to perform operations comprising receiving an input sequence comprising a set of input classes and a set of elapsed time indicators respectively corresponding to the set of input classes; generating, using an embedding layer of a mixed model pipeline, a sequence of learned class embeddings based on the set of input classes; generating, using the embedding layer of the mixed model pipeline, an input sequence embedding for the input sequence by concatenating the sequence of learned class embeddings with the set of elapsed time indicators; generating, using the embedding layer of the mixed model pipeline, a hidden state representation of the input sequence based on the input sequence embedding; inputting the hidden state representation to (i) a connected classification layer of the mixed model pipeline to receive a class prediction based on the hidden state representation and (ii) a connected regression layer of the mixed model pipeline to receive a time prediction based on the hidden state representation; and providing an aggregate output for the input sequence that identifies the class prediction and the time prediction.

Example 12. The system of example 11, wherein the operations further comprise, responsive to a match between the class prediction and a terminating class, providing the aggregate output as at least a portion of a predicted sequence.

Example 13. The system of examples 11 or 12, wherein the operations further comprise, responsive to a mismatch between the class prediction and a terminating class, (i) concatenating the aggregate output to the input sequence to generate a next-iteration input sequence and (ii) generating a next-iteration aggregate output based on the next-iteration input sequence.

Example 14. The system of any of examples 11 through 13, wherein the operations further comprise responsive to a first determination that a number of the set of input classes exceeds a sequence length threshold, (i) determining an input class subset from the set of input classes based on the sequence length threshold and the set of elapsed time indicators and (ii) generating the sequence of learned class embeddings based on the input class subset; or responsive to a second determination that the number of the set of input classes does not meet the sequence length threshold, (i) determining a padded class set comprising (a) the set of input classes and (b) a padded class and (ii) generating the sequence of learned class embeddings based on the padded class set.

Example 15. The system of any of examples 11 through 14, wherein the connected classification layer and the connected regression layer of the mixed model pipeline are jointly trained based on a dual loss function that determines a classification loss for the connected classification layer and a regression loss for the connected regression layer.

Example 16. The system of any of examples 11 through 15, wherein the input sequence embedding for the input sequence comprises a set of input embeddings and an input embedding of the set of input embeddings comprises a learned class embedding from the sequence of learned class embeddings and an elapsed time indicator corresponding to the learned class embedding.

Example 17. One or more non-transitory computer-readable media storing processor-executable instructions that, when executed by one or more processors, cause the one or more processors to perform operations comprising receiving an input sequence comprising a set of input classes and a set of elapsed time indicators respectively corresponding to the set of input classes; generating, using an embedding layer of a mixed model pipeline, a sequence of learned class embeddings based on the set of input classes; generating, using the embedding layer of the mixed model pipeline, an input sequence embedding for the input sequence by concatenating the sequence of learned class embeddings with the set of elapsed time indicators; generating, using the embedding layer of the mixed model pipeline, a hidden state representation of the input sequence based on the input sequence embedding; inputting the hidden state representation to (i) a connected classification layer of the mixed model pipeline to receive a class prediction based on the hidden state representation and (ii) a connected regression layer of the mixed model pipeline to receive a time prediction based on the hidden state representation; and providing an aggregate output for the input sequence that identifies the class prediction and the time prediction.

Example 18. The one or more non-transitory computer-readable media of example 17, wherein the connected classification layer and the connected regression layer of the mixed model pipeline are jointly trained based on a dual loss function that determines a classification loss for the connected classification layer and a regression loss for the connected regression layer.

Example 19. The one or more non-transitory computer-readable media of example 18, wherein the classification loss comprises a sparse categorical cross entropy loss and the regression loss comprises a mean squared error loss.

Example 20. The one or more non-transitory computer-readable media of examples 18 or 19, wherein the hidden state representation is generated by a machine learned embedding model, and one or more of the machine learned embedding model, the connected classification layer, or the connected regression layer are jointly trained.

Example 21. The computer-implemented method of example 1, wherein the method further comprises training the mixed model pipeline.

Example 22. The computer-implemented method of example 21, wherein the training is performed by the one or more processors.

Example 23. The computer-implemented method of example 21, wherein the one or more processors are comprised in a first computing entity; and the training is performed by one or more other processors comprised in a second computing entity.

Example 24. The computing system of example 11, wherein the one or more processors are further configured to train the mixed model pipeline.

Example 25. The computing system of example 24, wherein the one or more processors are comprised in a first computing entity; and the mixed model pipeline is trained by one or more other processors comprised in a second computing entity.

Example 26. The one or more non-transitory computer-readable storage media of example 17, wherein the instructions further cause the one or more processors to train the mixed model pipeline model.

Example 27. The one or more non-transitory computer-readable storage media of example 26, wherein the one or more processors are comprised in a first computing entity; and the mixed model pipeline is trained by one or more other processors comprised in a second computing entity.

What is claimed is:

1. A computer-implemented method comprising:
receiving, by one or more processors, an input sequence comprising a set of input classes and a set of elapsed time indicators respectively corresponding to the set of input classes;
generating, by the one or more processors and using an embedding layer of a mixed model pipeline, a sequence of learned class embeddings based on the set of input classes;
generating, by the one or more processors and using the embedding layer of the mixed model pipeline, an input sequence embedding for the input sequence by concatenating the sequence of learned class embeddings with the set of elapsed time indicators;
generating, by the one or more processors and using the embedding layer of the mixed model pipeline, a hidden state representation of the input sequence based on the input sequence embedding;
inputting, by the one or more processors, the hidden state representation to (i) a connected classification layer of the mixed model pipeline to receive a class prediction based on the hidden state representation and (ii) a connected regression layer of the mixed model pipeline to receive a time prediction based on the hidden state representation; and
providing, by the one or more processors, an aggregate output for the input sequence that identifies the class prediction and the time prediction.

1. A computer-implemented method comprising:
receiving, by one or more processors, an input sequence comprising a set of input classes and a set of elapsed time indicators respectively corresponding to the set of input classes;
generating, by the one or more processors and using an embedding layer of a mixed model pipeline, a sequence of learned class embeddings based on the set of input classes;
generating, by the one or more processors and using the embedding layer of the mixed model pipeline, an input sequence embedding for the input sequence by concatenating the sequence of learned class embeddings with the set of elapsed time indicators;
generating, by the one or more processors and using the embedding layer of the mixed model pipeline, a hidden state representation of the input sequence based on the input sequence embedding;
inputting, by the one or more processors, the hidden state representation to (i) a connected classification layer of the mixed model pipeline to receive a class prediction based on the hidden state representation and (ii) a connected regression layer of the mixed model pipeline to receive a time prediction based on the hidden state representation; and
providing, by the one or more processors, an aggregate output for the input sequence that identifies the class prediction and the time prediction.

2. The computer-implemented method of claim 1, further comprising, responsive to a match between the class prediction and a terminating class, providing the aggregate output as at least a portion of a predicted sequence.

3. The computer-implemented method of claim 1, further comprising, responsive to a mismatch between the class prediction and a terminating class, (i) concatenating the aggregate output to the input sequence to generate a next-iteration input sequence and (ii) generating a next-iteration aggregate output based on the next-iteration input sequence.

4. The computer-implemented method of claim 1, further comprising:
responsive to a first determination that a number of the set of input classes exceeds a sequence length threshold, (i) determining an input class subset from the set of input classes based on the sequence length threshold and the set of elapsed time indicators and (ii) generating the sequence of learned class embeddings based on the input class subset; or
responsive to a second determination that the number of the set of input classes does not meet the sequence length threshold, (i) determining a padded class set comprising (a) the set of input classes and (b) a padded class and (ii) generating the sequence of learned class embeddings based on the padded class set.

5. The computer-implemented method of claim 1, wherein the connected classification layer and the connected regression layer of the mixed model pipeline are jointly trained based on a dual loss function that determines a classification loss for the connected classification layer and a regression loss for the connected regression layer.

6. The computer-implemented method of claim 5, wherein the classification loss comprises a sparse categorical cross entropy loss and the regression loss comprises a mean squared error loss.

7. The computer-implemented method of claim 5, wherein the hidden state representation is generated by a machine learned embedding model, and one or more of the machine learned embedding model, the connected classification layer, or the connected regression layer are jointly trained.

8. The computer-implemented method of claim 7, wherein the machine learned embedding model comprises a recurrent neural network.

9. The computer-implemented method of claim 7, wherein at least one of the machine learned embedding model, the connected classification layer, or the connected regression layer is trained based on an aggregated loss that combines the classification loss and the regression loss.

10. The computer-implemented method of claim 1, wherein the input sequence embedding for the input sequence comprises a set of input embeddings and an input embedding of the set of input embeddings comprises a learned class embedding from the sequence of learned class embeddings and an elapsed time indicator corresponding to the learned class embedding.

11. A system comprising:
one or more processors; and
one or more memories storing processor-executable instructions that, when executed by the one or more processors, cause the one or more processors to perform operations comprising:
receiving an input sequence comprising a set of input classes and a set of elapsed time indicators respectively corresponding to the set of input classes;
generating, using an embedding layer of a mixed model pipeline, a sequence of learned class embeddings based on the set of input classes;
generating, using the embedding layer of the mixed model pipeline, an input sequence embedding for the input sequence by concatenating the sequence of learned class embeddings with the set of elapsed time indicators;
generating, using the embedding layer of the mixed model pipeline, a hidden state representation of the input sequence based on the input sequence embedding;
inputting the hidden state representation to (i) a connected classification layer of the mixed model pipeline to receive a class prediction based on the hidden state representation and (ii) a connected regression layer of the mixed model pipeline to receive a time prediction based on the hidden state representation; and
providing an aggregate output for the input sequence that identifies the class prediction and the time prediction.

12. The system of claim 11, wherein the operations further comprise, responsive to a match between the class prediction and a terminating class, providing the aggregate output as at least a portion of a predicted sequence.

13. The system of claim 11, wherein the operations further comprise, responsive to a mismatch between the class prediction and a terminating class, (i) concatenating the aggregate output to the input sequence to generate a next-iteration input sequence and (ii) generating a next-iteration aggregate output based on the next-iteration input sequence.

14. The system of claim 11, wherein the operations further comprise:
responsive to a first determination that a number of the set of input classes exceeds a sequence length threshold, (i) determining an input class subset from the set of input classes based on the sequence length threshold and the set of elapsed time indicators and (ii) generating the sequence of learned class embeddings based on the input class subset; or
responsive to a second determination that the number of the set of input classes does not meet the sequence length threshold, (i) determining a padded class set comprising (a) the set of input classes and (b) a padded class and (ii) generating the sequence of learned class embeddings based on the padded class set.

15. The system of claim 11, wherein the connected classification layer and the connected regression layer of the mixed model pipeline are jointly trained based on a dual loss function that determines a classification loss for the connected classification layer and a regression loss for the connected regression layer.

16. The system of claim 11, wherein the input sequence embedding for the input sequence comprises a set of input embeddings and an input embedding of the set of input embeddings comprises a learned class embedding from the sequence of learned class embeddings and an elapsed time indicator corresponding to the learned class embedding.

17. One or more non-transitory computer-readable media storing processor-executable instructions that, when executed by one or more processors, cause the one or more processors to perform operations comprising:
receiving an input sequence comprising a set of input classes and a set of elapsed time indicators respectively corresponding to the set of input classes;
generating, using an embedding layer of a mixed model pipeline, a sequence of learned class embeddings based on the set of input classes;
generating, using the embedding layer of the mixed model pipeline, an input sequence embedding for the input sequence by concatenating the sequence of learned class embeddings with the set of elapsed time indicators;
generating, using the embedding layer of the mixed model pipeline, a hidden state representation of the input sequence based on the input sequence embedding;
inputting the hidden state representation to (i) a connected classification layer of the mixed model pipeline to receive a class prediction based on the hidden state representation and (ii) a connected regression layer of the mixed model pipeline to receive a time prediction based on the hidden state representation; and
providing an aggregate output for the input sequence that identifies the class prediction and the time prediction.

18. The one or more non-transitory computer-readable media of claim 17, wherein the connected classification layer and the connected regression layer of the mixed model pipeline are jointly trained based on a dual loss function that determines a classification loss for the connected classification layer and a regression loss for the connected regression layer.

19. The one or more non-transitory computer-readable media of claim 18, wherein the classification loss comprises a sparse categorical cross entropy loss and the regression loss comprises a mean squared error loss.

20. The one or more non-transitory computer-readable media of claim 18, wherein the hidden state representation is generated by a machine learned embedding model, and one or more of the machine learned embedding model, the connected classification layer, or the connected regression layer are jointly trained.
